(19) United States
(12) Patent Application Publication
(10) Pub. No.: US 2024/0129037 A1
(43) Pub. Date: Apr. 18, 2024

(54) TRANSMITTER, TRANSMISSION DEVICE, COMMUNICATION DEVICE, AND COMMUNICATION SYSTEM

(71) Applicant: NEC Corporation, Tokyo (JP)

(72) Inventors: Fujio OKUMURA, Kanagawa (JP); Hiroshi Imai, Tokyo (JP)

(73) Assignee: NEC Corporation, Tokyo (JP)

(21) Appl. No.: 18/371,064

(22) Filed: Sep. 21, 2023

(30) Foreign Application Priority Data
Oct. 13, 2022 (JP) 2022-164679

(51) Int. Cl. H04B 10/50; H04B 10/548

(52) U.S. Cl. CPC H04B 10/501; H04B 10/548

(57) ABSTRACT

A transmitter includes a light source including a first light emitter and a second light emitter, a spatial light modulator including a modulation part that modulates light emitted from the light source, a first mirror that is arranged on a first optical path of the modulated light modulated by the modulation part and reflects the modulated light toward a first projection direction, and a second mirror that is arranged on a second optical path of the modulated light modulated by the modulation part and reflects the modulated light toward the first projection direction.

This application is based upon and claims the benefit of priority from Japanese Patent Application No. 2022-164679, filed on Oct. 13, 2022, the disclosure of which is incorporated herein in its entirety by reference.

### TECHNICAL FIELD

The present disclosure relates to a transmitter or the like that transmits an optical signal propagating in a space.

### BACKGROUND ART

In optical space communication, communication using optical signals (hereinafter, spatial light signals) propagating in a space is performed without using a medium such as an optical fiber. In order to transmit the spatial light signal in a wide range, it is preferable that the projection angle of the projection light is as wide as possible. For example, if a light transmission device including a phase modulation-type spatial light modulator is used, the projection angle can be widened by controlling the pattern set in the modulation part of the spatial light modulator. If the spatial light signal can be transmitted in a plurality of directions around the light transmission device, a communication network using the spatial light signal can be constructed.

Patent Literature 1 (WO 2018/056194 A) discloses a projection system including a phase modulation-type spatial light modulation element. The system of Patent Literature 1 includes a projection means, a control means, and a reflecting mirror. The projection means includes a light source, a spatial light modulator, and an optical system. The spatial light modulation element is a phase modulation-type element and includes a display unit that displays a pattern corresponding to the display information. The spatial light modulation element emits modulated light of the light emitted from the light source to the display unit. The optical system projects the modulated light emitted from the spatial light modulation element. The control means generates a control condition for controlling the light source and the spatial light modulation element on the basis of the display condition acquired from the host system. The control means controls the light source and the spatial light modulation element on the basis of the generated control condition. The reflecting mirror reflects the projection light of the projection means toward the plurality of display regions.

According to the method of Patent Literature 1, display information with sufficient brightness can be projected on a plurality of display regions without distortion by distortion correction using a reflecting mirror. For example, when a reflecting mirror (curved mirror) having a curved reflecting surface projecting in the projection direction is used, the projection angle of the projection light can be increased according to the curvature of the reflecting surface. The beam diameter of the projection light is adjusted to have an optimum size at the position of the communication target. For example, in a case where the distance to the communication target is 100 m (meters), when projection light having a beam diameter of 65 to 70 mm (millimeters) is projected at the position of the communication target, the beam diameter of the projection light immediately after the projection is about 2 to 7 mm. Therefore, during rainfall, there is a possibility that projection light immediately after projection is blocked by rain particles and communication with a communication target is interrupted.

An object of the present disclosure is to provide a transmitter or the like that is less susceptible to weather and can realize continuous optical spatial communication.

### SUMMARY

A transmitter according to one aspect of the present disclosure includes a light source including a first light emitter and a second light emitter, a spatial light modulator including a modulation part that modulates light emitted from the light source, a first mirror that is disposed on a first optical path of the modulated light modulated by the modulation part and reflects the modulated light toward a first projection direction, and a second mirror that is disposed on a second optical path of the modulated light modulated by the modulation part and reflects the modulated light toward the first projection direction.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a transmission device according to a first example embodiment;

FIG. 2 is a conceptual diagram illustrating an example of a configuration of a light source included in the transmission device according to the first example embodiment;

FIG. 3 is a conceptual diagram illustrating an arrangement example of mirrors included in the transmission device according to the first example embodiment;

FIG. 4 is a conceptual diagram illustrating an arrangement example of mirrors included in the transmission device according to the first example embodiment;

FIG. 5 is a conceptual diagram for describing an influence of rainfall on projection light projected from a transmission device of a comparative example;

FIG. 6 is a conceptual diagram for describing an influence of rainfall on projection light projected from the transmission device according to the first example embodiment;

FIG. 7 is a graph for describing an example of driving of the light source by the control unit of the transmission device according to the first example embodiment;

FIG. 8 is a conceptual diagram illustrating an example of a configuration of a transmission device according to a second example embodiment;

FIG. 9 is a conceptual diagram illustrating an example of a configuration of a light source included in the transmission device according to a second example embodiment;

FIG. 10 is a conceptual diagram illustrating an arrangement example of mirrors included in the transmission device according to the second example embodiment;

FIG. 11 is a conceptual diagram illustrating an arrangement example of mirrors included in the transmission device according to the second example embodiment;

FIG. 12 is a conceptual diagram illustrating an example of a configuration of a transmission device according to a third example embodiment;

FIG. 13 is a conceptual diagram illustrating an arrangement example of mirrors included in the transmission device according to the third example embodiment;

FIG. 14 is a conceptual diagram illustrating an arrangement example of mirrors included in the transmission device according to the third example embodiment;

FIG. 15 is a conceptual diagram illustrating an example of a configuration of a transmission device according to a fourth example embodiment;

FIG. 16 is a conceptual diagram illustrating an arrangement example of mirrors included in the transmission device according to the fourth example embodiment;

FIG. 17 is a conceptual diagram illustrating an arrangement example of mirrors included in the transmission device according to the fourth example embodiment;

FIG. 18 is a conceptual diagram illustrating an example of projection of the projection light projected from the transmission device according to the fourth example embodiment;

FIG. 19 is a conceptual diagram illustrating an example of projection of the projection light projected from the transmission device according to the fourth example embodiment;

FIG. 20 is a conceptual diagram illustrating an example of projection of the projection light projected from the transmission device according to the fourth example embodiment;

FIG. 21 is a conceptual diagram illustrating an example of a configuration of a communication device according to a fifth example embodiment;

FIG. 22 is a conceptual diagram illustrating an example of a configuration of a reception device included in the communication device according to the fifth example embodiment;

FIG. 23 is a conceptual diagram illustrating an example of a configuration of a communication device according to an application example of the fifth example embodiment;

FIG. 24 is a conceptual diagram illustrating an example of a communication system including the communication device according to the application example of the fifth example embodiment;

FIG. 25 is a conceptual diagram illustrating an example of a configuration of a transmitter according to a sixth example embodiment; and

FIG. 26 is a conceptual diagram illustrating an example of a hardware configuration that executes control and processing according to each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. The line indicating the trajectory of light in the drawings is conceptual, and does not accurately indicate the actual traveling direction or state of light. For example, in the drawings, a change in a traveling direction or a state of light due to refraction, reflection, diffusion, or the like at an interface between air and a substance may be omitted, or a light flux may be expressed by one line. In addition, there is a case where hatching is not applied to the cross-section for reasons such as showing an example of the path of light or the configuration being complicated.

### First Example Embodiment

First, a transmission device according to a first example embodiment will be described with reference to the drawings. The transmission device of the present example embodiment is used for optical space communication in which optical signals (hereinafter, spatial light signals) propagating in a space are transmitted and received without using a medium such as an optical fiber. The transmission device of the present example embodiment may be used for applications other than optical space communication as long as the transmission device transmits light propagating in a space. Note that the drawings used in the description of the present example embodiment are conceptual and do not accurately depict an actual structure.

(Configuration)

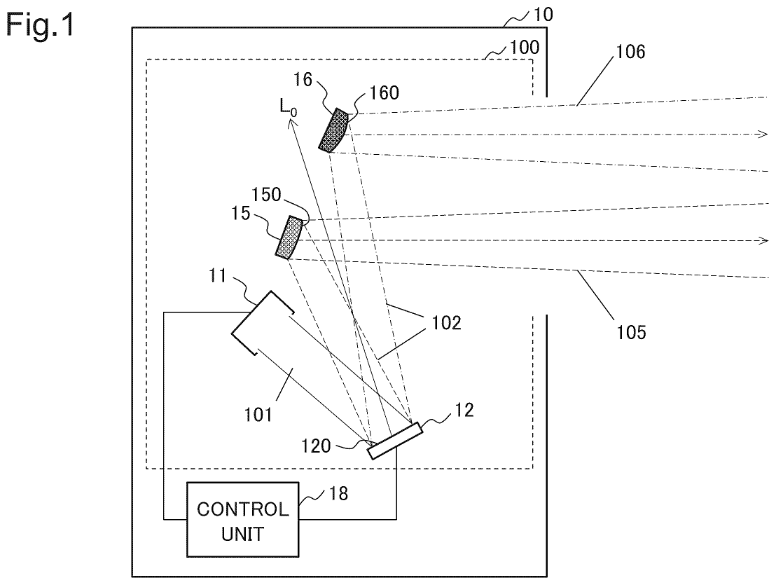

FIG. 1 is a conceptual diagram illustrating an example of a configuration of a transmission device 10 according to the present example embodiment. The transmission device 10 includes a light source 11, a spatial light modulator 12, a first mirror 15, a second mirror 16, and a control unit 18. The light source 11, the spatial light modulator 12, the first mirror 15, and the second mirror 16 constitute a transmitter 100. FIG. 1 is a conceptual diagram of an internal configuration of the transmission device 10 as viewed from a lateral direction. FIG. 1 is conceptual, and does not accurately represent a shape of each component, a positional relationship between components, traveling of light, and the like.

The light source 11 emits illumination light 101 under the control of the control unit 18. The illumination light 101 includes two beams. The light source 11 has an emission surface from which the illumination light 101 is emitted. The emission surface of the light source 11 is directed to the modulation part 120 of the spatial light modulator 12.

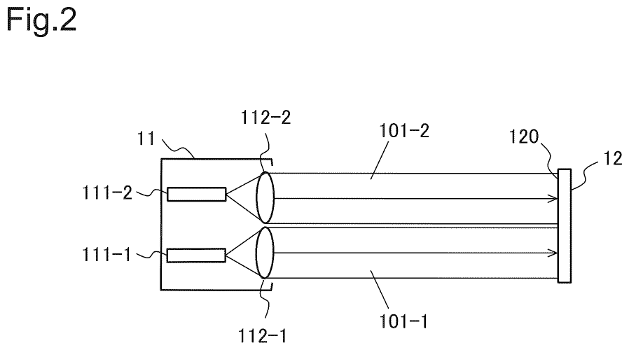

FIG. 2 is a conceptual diagram illustrating an example of a configuration of the light source 11. FIG. 2 is a view of the inside of the light source 11 viewed from a viewing seat vertically above the traveling direction of the illumination light 101. The light source 11 includes a light emitter 111-1, a light emitter 111-2, an optical system 112-1, and an optical system 112-2. The light emitter 111-1 is associated with the optical system 112-1. The light emitter 111-2 is associated with the optical system 112-2. The two beams (spatial light signals) derived from the light emitted from the light emitter 111-1 and the light emitter 111-2 are transmitted toward the same communication target. Therefore, the light emitted from the light emitter 111-1 and the light emitted from the light emitter 111-2 have the same modulation.

The light emitters 111-1 and 111-2 included in the light source 11 emit laser light in a predetermined wavelength band under the control of the control unit 18. The wavelength of the laser light emitted from the light emitters 111-1 and 111-2 is not particularly limited. The wavelength of the laser light may be selected according to the application. For example, the light emitters 111-1 and 111-2 emit laser light in visible or infrared wavelength bands. For example, near-infrared rays of 800 to 1000 nanometers (nm) can be given a laser class as compared with visible light, so that sensitivity can be improved as compared with visible light. For example, in the case of infrared rays in a wavelength band of 1.55 micrometers (μm), a laser light source having a higher output than near-infrared rays of 800 to 1000 nm can be used. As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set.

For example, the light emitters 111-1 and 111-2 included in the light source 11 are achieved by surface emitting lasers. An example of the surface emitting laser is a VCSEL (Vertical-Cavity Surface-Emitting Laser). The VCSEL laser emits laser light of circular radiation. Further, another example of the surface emitting laser is a PCSEL (Photonic Crystal Surface Emitting Laser). The PCSEL laser emits laser light of circular narrow radiation. Compared with the VCSEL laser, the PCSEL laser emits uniform laser light.

For example, the light emitters 111-1 and 111-2 included in the light source 11 are achieved by a fiber array laser. In the fiber array laser, a laser light source and an emission unit (optical system) are connected by an optical waveguide (optical fiber). The laser light emitted from the laser light source is emitted from the emission unit through the waveguide. When the fiber array type laser is used, the laser light source and the emission unit can be arranged at different positions. Therefore, if the fiber array type laser is used, the light emitters 111-1 and 111-2 can be arranged at a position away from the spatial light modulator 12, so that thermal interference hardly occurs even if the light-emitting portion and the spatial light modulator 12 are brought close to each other.

The optical system 112-1 is arranged in association with the light emitter 111-1. The optical system 112-2 is arranged in association with the light emitter 111-2. The optical system 112-1 converts the laser light emitted from the light emitter 111-1 into illumination light 101-1. The optical system 112-2 converts the laser light emitted from the light emitter 111-2 into illumination light 101-2. The converted illumination light beams 101-1 and 101-2 are emitted from the light source 11. The illumination light beams 101-1 and 101-2 travel toward the modulation part 120 of the spatial light modulator 12.

The spatial light modulator 12 is a two-dimensional phase modulator. The spatial light modulator 12 includes a modulation part 120 that modulates the emitted light. The spatial light modulator 12 of the present example embodiment includes a reflection-type modulation part 120. The modulation part 120 is irradiated with the illumination light beams 101-1 and 101-2 emitted from the light emitters 111-1 and 111-2. In the example of FIG. 1, the first mirror 15 and the second mirror 16 are arranged at a subsequent stage of the spatial light modulator 12.

In the modulation region of the modulation part 120, a pattern (phase image) corresponding to the image displayed by projection light 105 is set according to the control of the control unit 18. The illumination light 101-1 and the illumination light 2 incident on the modulation part 120 are modulated according to the pattern (phase image) set in the modulation region. The illumination light beams 101-1 and 101-2 is modulated into modulated light 102 in the modulation region. The modulated light 102 includes modulated light 102 derived from the illumination light 101-1 and the modulated light 102 derived from the illumination light 101-2.

The modulation region of the modulation part 120 is divided into a plurality of regions (tiling). For example, the modulation region is divided into regions (tiles) of a desired aspect ratio. A phase image is assigned to each of the plurality of tiles set in the modulation region. Each of the plurality of tiles includes a plurality of pixels. A phase image corresponding to the projected image is set to each tile. A phase image is tiled to each tile assigned to the modulation region. For example, a phase image generated in advance is set in each tile according to an image displayed by projection light. As the number of tiles set in the modulation region increases, a clear image can be displayed. On the other hand, as the number of tiles increases, the resolution decreases as the number of pixels of each tile decreases. Therefore, the size and number of tiles set in the modulation region are set according to the application.

When the modulation part 120 is irradiated with the illumination light 101 in a state where the phase images are set for the plurality of tiles, the modulated light 102 that forms an image corresponding to the phase image of each tile is emitted. The modulated light 102 includes light (desired light) projected as the projection light 105 or the projection light 106. The modulated light 102 travels toward the reflecting surface 150 of the first mirror 15 or the reflecting surface 160 of the second mirror 16. The modulated light 102 also includes an unnecessary light component such as 0th-order light L₀. The 0th-order light L₀ travels toward a region (dead region) between the first mirror and the second mirror 16.

For example, the spatial light modulator 12 is achieved by a spatial light modulator using ferroelectric liquid crystal, homogeneous liquid crystal, vertical alignment liquid crystal, or the like. For example, the spatial light modulator 12 can be achieved by liquid crystal on silicon (LCOS). Furthermore, the spatial light modulator 12 may be achieved by a micro electro mechanical system (MEMS). In the phase modulation-type spatial light modulator 12, the energy can be concentrated on the portion of the image by operating to sequentially switch the portion on which the projection light 105 is projected. Therefore, in the case of using the phase modulation-type spatial light modulator 12, if the output of the light source 11 is the same, the image can be displayed brighter than other methods.

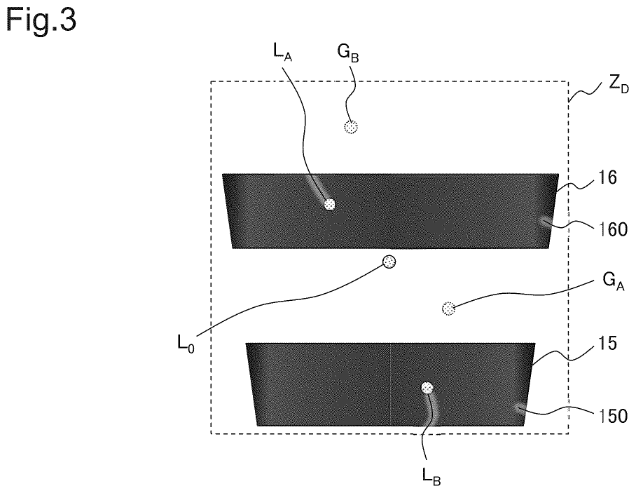

FIG. 3 is a conceptual diagram illustrating a positional relationship between the first mirror 15 and the second mirror 16. FIG. 3 is a conceptual diagram of the first mirror 15 and the second mirror 16 as viewed from the reflecting surface side. The first mirror 15 has a reflecting surface 150. The second mirror 16 has a reflecting surface 160. FIG. 3 illustrates an example in which the second mirror 16 is disposed above the first mirror 15. The second mirror 16 may be disposed below the first mirror 15. FIG. 3 illustrates a region (dead region Z_{D}) where the modulated light 102 is not reflected around the first mirror 15 and the second mirror 16. A region not illustrated in the peripheral regions of the first mirror 15 and the second mirror 16 is also included in the dead region Z_{D}.

FIG. 3 illustrates an example of positions irradiated with the 0th-order light L₀, the desired light L_{A}, the desired light L_{B}, the ghost image G_{A}, and the ghost image G_{B}. The 0th-order light L₀ is 0th-order diffracted light included in the modulated light 102. The desired light L_{A} and the desired light L_{B} are first-order diffracted light included in the modulated light 102. The desired light L_{A} and the desired light L_{B} are light to be projected. The ghost image G_{A} is light that appears at a point-symmetrical position with respect to the desired light L_{A} with the 0th-order light L₀ as the center. The ghost image G_{B} is light that appears at a point-symmetrical position with respect to the desired light L_{B} with the 0th-order light L₀ as the center. The ghost image G_{A} and the ghost image G_{B} are unnecessary light components (unnecessary light). Although not illustrated in FIG. 3, modulated light 102 includes diffracted light of second or higher order (high-order light). The high-order light is emitted to the dead region Z_{D} outside the region illustrated in FIG. 3.

In FIG. 3, the desired light L_{A} is emitted to the reflecting surface 160 of the second mirror 16. The desired light L_{A} emitted to the reflecting surface 160 is projected at a projection angle corresponding to the curvature of the reflecting surface 160. The desired light L_{B} is emitted to the reflecting surface 150 of the first mirror 15. The desired light L_{B} emitted to the reflecting surface 150 is projected at a projection angle corresponding to the curvature of the reflecting surface 150. The 0th-order light L₀ is emitted to the dead region Z_{D} near the reflecting surface 160. The dead region Z_{D} is irradiated with the ghost image G_{A} of the desired light L_{A} and the ghost image G_{B} of the desired light L_{B}.

The ghost image G of the desired light L appears at a point-symmetrical position of the desired light L with the 0th-order light L₀ as the center. The first mirror 15 and the second mirror 16 are arranged while avoiding a region where the ghost image G is displayed. With such an arrangement, the 0th-order light L₀, the ghost image G_{A}, and the ghost image G_{B} are not emitted to the reflecting surface 150 and the reflecting surface 160. In addition, the high-order light included in the modulated light 102 is emitted to the dead region Z_{D} deviated from the region illustrated in FIG. 3. Therefore, the 0th-order light L₀, the ghost image G_{A}, the ghost image G_{B}, and the high-order light are not projected to the outside.

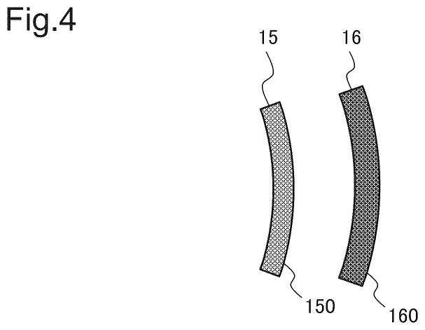

FIG. 4 is a conceptual diagram illustrating a positional relationship between the first mirror 15 and the second mirror 16. FIG. 4 is a cross-sectional view of the first mirror 15 and the second mirror 16 as viewed from above. In the sheet of FIG. 4, the reflecting surface 150 of the first mirror 15 and the reflecting surface 160 of the second mirror 16 are directed rightward. FIG. 4 illustrates an example in which the second mirror 16 is disposed in front of the first mirror 15. The second mirror 16 may be disposed behind the first mirror 15.

The first mirror 15 is a curved mirror having a curved reflecting surface 150. The convex surface of the first mirror 15 is the reflecting surface 150. The reflecting surface 150 has a curvature corresponding to a projection angle of the projection light 105. The reflecting surface 150 has a curvature (first curvature) corresponding to the projection angle of the projection light 105 in the horizontal plane. The projection light 105 spreads in a fan shape in accordance with the curvature (first curvature) of the reflecting surface 150 in the horizontal plane. The reflecting surface 150 has a curvature (second curvature) corresponding to a projection angle of the projection light 105 in the vertical plane. The projection light 105 spreads in accordance with the curvature (second curvature) of the reflecting surface 150 in the vertical plane. The projection light 105 is projected in a rectangular band shape in a vertical plane. The first mirror 15 is disposed with the reflecting surface 150 facing the modulation part 120 of the spatial light modulator 12. The first mirror 15 is disposed on the optical path (first optical path) of the modulated light 102 modulated by the modulation part of the spatial light modulator 12. The first mirror 15 is disposed while avoiding a position irradiated with an unnecessary light component (unnecessary light) included in the modulated light 102. The reflecting surface 150 is irradiated with light to be projected (desired light) in the modulated light 102. The modulated light 102 emitted to the reflecting surface 150 is reflected by the reflecting surface 150. The desired light reflected by the reflecting surface 150 is projected as the projection light 105. The projection light 105 is enlarged at an enlargement ratio corresponding to the curvature of the reflecting surface 150.

The second mirror 16 is a curved mirror having a curved reflecting surface 160. The convex surface of the second mirror 16 is a reflecting surface. The reflecting surface 160 has a curvature corresponding to a projection angle of the projection light 106. The curvature of the reflecting surface 160 is similar to the curvature of the reflecting surface 150 of the first mirror 15. The second mirror 16 is disposed with the reflecting surface 160 facing the modulation part 120 of the spatial light modulator 12. The second mirror 16 is disposed on the optical path (second optical path) of the modulated light 102 modulated by the modulation part 120. The second mirror 16 is disposed while avoiding a position irradiated with unnecessary light included in the modulated light 102. The reflecting surface 160 is irradiated with desired light of the modulated light 102. The modulated light 102 emitted to the reflecting surface 160 is reflected by the reflecting surface 160. The desired light reflected by the reflecting surface 160 is projected as the projection light 106. The projection light 106 is enlarged at an enlargement ratio corresponding to the curvature of the reflecting surface 160.

The curvatures of the reflecting surface 150 and the reflecting surface 160 may be the same or different. For example, the curvature of the reflecting surface 150 may be smaller than the curvature of the reflecting surface 160. For example, the curvature of the reflecting surface 150 may be larger than the curvature of the reflecting surface 160.

The shapes of the reflecting surface 150 and the reflecting surface 160 are not limited as long as they include a curved portion. For example, the reflecting surface 150 and the reflecting surface 160 have the shape of a side surface of a cylinder. For example, the reflecting surface 150 and the reflecting surface 160 may be a free-form surface or a spherical surface. For example, the reflecting surface 150 and the reflecting surface 160 may have a shape obtained by combining a plurality of curved surfaces. For example, the reflecting surface 150 and the reflecting surface 160 may have a shape obtained by combining a curved surface and a flat surface.

The projection lights 105 to 106 are transmitted as a spatial light signal through a slit (not illustrated) opened in a housing of the transmission device 10. The projection lights 105 to 106 spread as they go away from the transmission device 10. In the distance reaching the communication target, the projection range of the projection lights 105 to 106 is substantially the same. For example, a lens (not illustrated) may be disposed at a subsequent stage of the first mirror 15 and the second mirror 16. In this case, the lens satisfies a condition that the projection lights 105 to 106 reflected by the first mirror 15 and the second mirror 16 travel toward the same communication target. The lens is arranged to limit the spread of the projection lights 105 to 106 or to enlarge the spread of the projection lights 105 to 106. The structure and shape of the lens may be determined according to the application.

The control unit 18 controls the light source 11 and the spatial light modulator 12. For example, the control unit 18 is achieved by a microcomputer including a processor and a memory. The control unit 18 sets a phase image corresponding to the projected image in the modulation part 120 in accordance with the aspect ratio of tiling set in the modulation part 120 of the spatial light modulator 12. The control unit 18 sets a phase image corresponding to the projected image in the modulation region set in the modulation part 120 of the spatial light modulator 12. For example, the control unit 18 sets, in the modulation part 120, a phase image corresponding to an image according to a use such as image display, communication, or distance measurement. The phase image of the projected image may be stored in advance in a storage unit (not illustrated). The shape and size of the image to be projected are not particularly limited.

The control unit 18 controls the spatial light modulator 12 such that a parameter that determines a difference between a phase of the illumination light 101 emitted to the modulation part 120 and a phase of the modulated light 102 reflected by the modulation part 120 changes. For example, the parameter is a value related to optical characteristics such as a refractive index and an optical path length. For example, the control unit 18 adjusts the refractive index of the modulation part 120 by changing the voltage applied to the modulation part 120 of the spatial light modulator 12. The phase distribution of the illumination light 101 with which the modulation part 120 of the phase modulation-type spatial light modulator 12 is irradiated is modulated according to the optical characteristics of the modulation part 120. Note that the method of driving the spatial light modulator 12 by the control unit 18 is determined according to the modulation scheme of the spatial light modulator 12.

The control unit 18 drives the light source 11 in a state in which the phase image corresponding to the displayed image is set in the modulation part 120 of the spatial light modulator 12. As a result, with the phase image set in the modulation part 120, the modulation part 120 is irradiated with the illumination light 101 emitted from the light source 11. The illumination light 101 emitted to the modulation part 120 is modulated by the modulation part 120. The modulated light 102 modulated by the modulation part 120 is emitted toward the first mirror 15 and the second mirror 16.

Furthermore, the control unit 18 modulates the illumination light 101 emitted from the light source 11 for communication with a communication target (not illustrated). In communication, the control unit 18 controls the timing at which the illumination light 101 is emitted from the light source 11 in a state where the phase image for communication is set in the modulation part 120 of the spatial light modulator 12. By such control, the illumination light 101 is modulated. The modulation pattern of the illumination light 101 in the communication is arbitrarily set. For example, a configuration for communication (communication unit) may be added separately from the control unit 18. In that case, the control unit 18 may be configured to control the light source 11 and the spatial light modulator 12 according to the condition set by the communication unit.

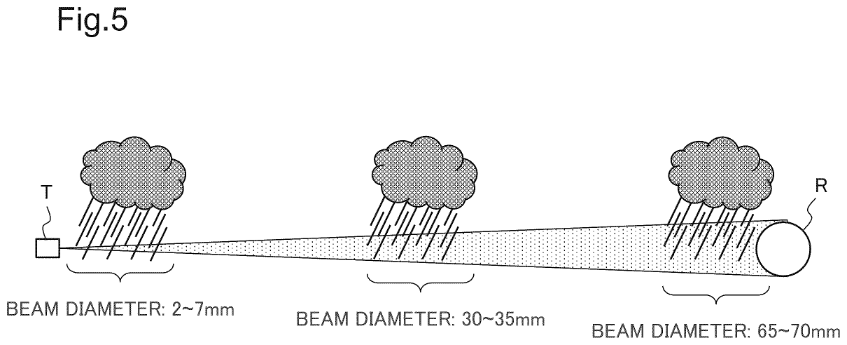

FIG. 5 is a conceptual diagram for explaining the influence of rainfall on the spatial light signal transmitted from a communication device T of a comparative example. The communication device T projects a spatial light signal including a single projection light toward the communication device R. The beam diameter of the spatial light signal immediately after transmission from the communication device T is 2 to 7 mm (mm). When the distance between the communication device T and the communication device R is about 100 m (meters), the beam diameter of the spatial light signal transmitted from the communication device T increases to about 65 to 70 mm at the stage of reaching the communication device R. In this case, the beam diameter of the spatial light signal is about 30 to 35 mm at the intermediate position between the communication device T and the communication device R. In general, the size of a raindrop is about 0.1 to 8 mm. Therefore, the spatial light signal immediately after transmission in which the beam diameter of the spatial light signal is 2 to 7 mm may be blocked by raindrops. On the other hand, since the beam diameter exceeds 30 mm after the intermediate position between the communication device T and the communication device R, the remaining light can reach the communication device R even if some light is blocked.

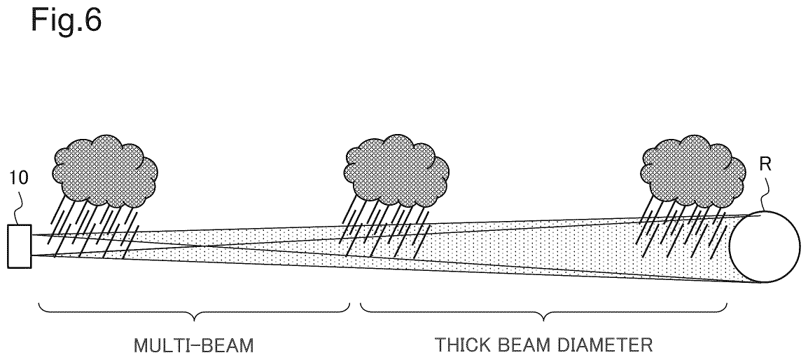

FIG. 6 is a conceptual diagram for describing an influence of rainfall on a spatial light signal transmitted from the transmission device 10 of the present example embodiment. In the example of FIG. 6, a spatial light signal (projection light) is transmitted from the transmission device 10 to the communication device R. In the case of the example of FIG. 6, the transmission device 10 transmits a spatial light signal including two beams (multiple beams). In the spatial light signal immediately after transmission from the transmission device 10, even if one beam is blocked by a raindrop, the other beam can travel without being blocked. In addition, since the beam diameter of the spatial light signal increases at a point sufficiently away from the transmission device 10, the remaining light can reach the communication device R even if some light is blocked. In the present example embodiment, the vicinity of the transmission device has multiple beams, and the beam diameter increases at a position away from the transmission device 10, so that the influence of raindrops is less likely to occur. The blocking of the spatial light signal depends not only on rain drops but also on whether such as snow, hail, and hail. According to the present example embodiment, continuous optical space communication can be achieved without being affected by the weather as well as rainfall.

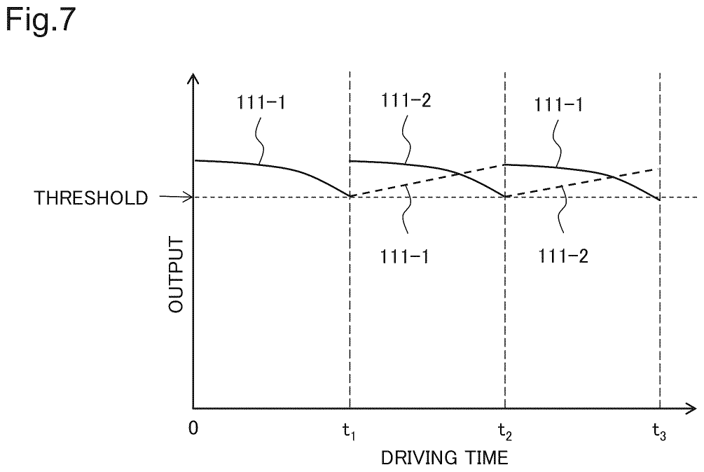

FIG. 7 is a graph for describing a control example by the control unit 18 of the transmission device 10 according to the present example embodiment. The graph of FIG. 7 illustrates a control example of the transmission device 10 in a case of weather such as fine weather or cloudy weather. It is not necessary to form multiple beams unless the weather is such as when it rains. The example of FIG. 7 illustrates a control pattern for alternately driving the two light emitters 111-1 and 111-2.

The graph of FIG. 7 shows the transition of the output of the light emitters 111-1 and 111-2 according to the driving time. The output of the light emitters 111-1 and 111-2 decreases due to the temperature rise according to the elapse of the driving time. Therefore, in the example of FIG. 7, the used light emitters 111-1 and 111-2 are switched according to the decrease in output.

In the example of FIG. 7, the light emitter 111-1 is used in the time period of time 0 to t₁. As the driving time elapses, the output of the light emitter 111-1 decreases (solid line). At time t₁, the output of the light emitter 111-1 reaches the threshold value. At this timing, the light emitter 111-1 is deactivated and the light emitter 111-2 is driven. As a result, the overall output of the light source 11 is recovered. In the time period from time t₁ to t₂, the light emitter 111-2 is used. As the driving time elapses, the output of the light emitter 111-2 decreases (solid line). On the other hand, the output of the light emitter 111-1 is recovered (broken line). At time t₂, when the output of the light emitter 111-2 reaches the threshold value, the light emitter 111-2 is deactivated and the light emitter 111-1 is driven. In the time period from time t₂ to t₃, the light emitter 111-1 is used. As the driving time elapses, the output of the light emitter 111-1 decreases (solid line). On the other hand, the output of the light emitter 111-2 is recovered (broken line). After time t₃, the light source 11 may be controlled in a similar control pattern.

As in the control example of FIG. 7, when the two light emitters 111-1 and 111-2 are alternately driven, the light emitter 111 whose output has decreased due to the temperature rise is deactivated, and the temperature of the light emitter 111 is decreased, so that the output can be expected to be recovered. The number of light emitters 111 is not limited to two, and may be three or more. According to the control example of FIG. 7, by sequentially using the plurality of light emitters 111 included in the light source 11, it is possible to suppress a decrease in output due to a temperature rise of the light emitters 111. That is, according to the control example of FIG. 7, by driving the plurality of light emitters 111 included in the light source 11 at timings independent from each other, it is possible to suppress a decrease in output due to a temperature rise of the light emitters 111. In a case where different communication targets communicate with each other, a plurality of light emitters 111 may be allocated to channels for each communication target.

As described above, the transmission device according to the present example embodiment includes the light source, the spatial light modulator, the first mirror, the second mirror, and the control unit. The light source includes a first light emitter and a second light emitter. The spatial light modulator includes a modulation part that modulates the light emitted from the light source. The first mirror has a convex curved reflecting surface. The first mirror is disposed on the first optical path of the modulated light modulated by the modulation part. The first mirror is disposed with the reflecting surface facing the first projection direction. The reflecting surface of the first mirror reflects the modulated light in the first projection direction. The second mirror has a convex curved reflecting surface. The second mirror is disposed on the second optical path of the modulated light modulated by the modulation part. The second mirror is disposed with the reflecting surface facing the first projection direction. The reflecting surface of the second mirror reflects the modulated light in the first projection direction. The control unit sets the phase image used for the spatial light communication in the modulation part of the spatial light modulator included in the transmitter. The control unit controls a light source included in the transmitter so that the modulation part is irradiated with light.

In the present example embodiment, the beams of the spatial light signal (projection light) are separated into two by reflecting the illumination light derived from the light emitted from the two light emitters by the two reflecting surfaces. According to the present example embodiment, multiple beams configured by two beams are transmitted as a spatial light signal (projection light). Therefore, according to the present example embodiment, even if one beam is blocked by raindrops in rainfall, there is a high possibility that another beam reaches the communication target. According to the present example embodiment, by forming the spatial light signal (projection light) into two multiple beams, it is possible to realize continuous optical spatial communication which is hardly affected by the weather.

In one aspect of the present example embodiment, the first mirror and the second mirror are disposed while avoiding a position irradiated with a ghost image of desired light included in the modulated light and a position irradiated with 0th-order light included in the modulated light. According to the present aspect, since the reflecting surfaces of the first mirror and the second mirror are not irradiated with unnecessary light such as a ghost image and 0th-order light, unnecessary light can be excluded from projection light (spatial light signal) projected in the first projection direction.

In one aspect of the present example embodiment, the control unit drives the plurality of light emitters included in the light source at timings independent from each other. According to the present aspect, by alternately using the plurality of light emitters included in the light source, it is possible to reduce a decrease in output of the light source due to driving for a long time.

### Second Example Embodiment

Next, a transmission device according to a second example embodiment will be described with reference to the drawings. The transmission device of the present example embodiment includes a third mirror in addition to the first mirror and the second mirror. In this respect, the present example embodiment is different from the first example embodiment.

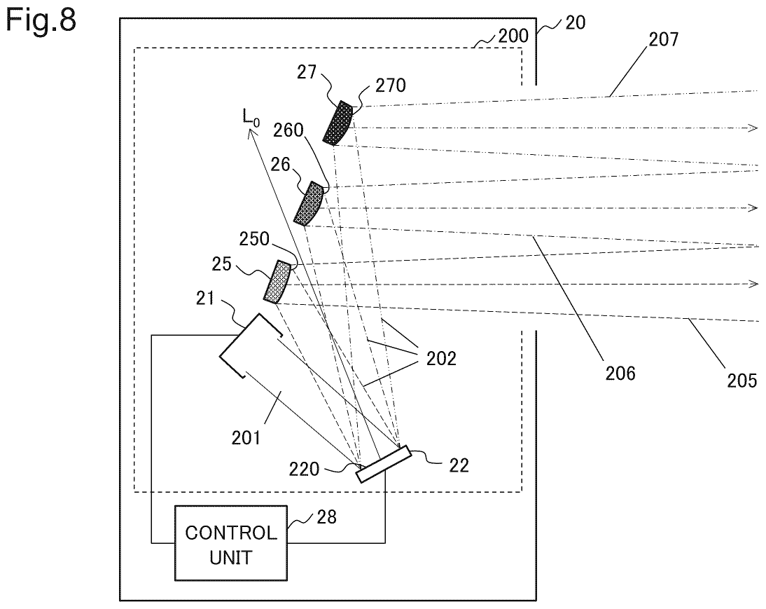

FIG. 8 is a conceptual diagram illustrating an example of a configuration of a transmission device 20 according to the present example embodiment. The transmission device 20 includes a light source 21, a spatial light modulator 22, a first mirror 25, a second mirror 26, a third mirror 27, and a control unit 28. The light source 21, the spatial light modulator 22, the first mirror 25, the second mirror 26, and the third mirror 27 constitute a transmitter 200. FIG. 8 is a conceptual diagram of the internal configuration of the transmission device 20 as viewed from the lateral direction. FIG. 8 is conceptual, and does not accurately represent the shape of each component, the positional relationship between components, the travel of light, and the like. The light source 21 emits illumination light 201 used for optical space communication. The light source 21 has an emission surface from which the illumination light 201 is emitted. The emission surface of the light source 21 is directed to the spatial light modulator 22. The light source 21 emits illumination light 201 toward the modulation part 220 of the spatial light modulator 22 under the control of the control unit 28. The illumination light 201 includes three beams (illumination light beams 201-1 to 201-3).

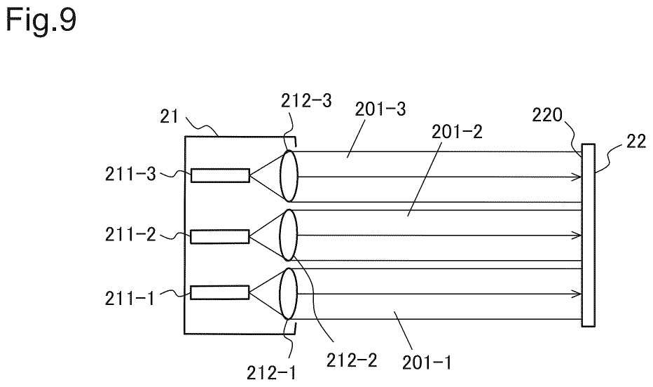

FIG. 9 is a conceptual diagram illustrating an example of a configuration of the light source 21. FIG. 9 is a view of the inside of the light source 21 viewed from a viewing seat vertically above the traveling direction of the illumination light 201. The light source 21 includes a light emitter 211-1, a light emitter 211-2, a light emitter 211-3, an optical system 212-1, an optical system 212-2, and an optical system 212-3. The light emitters 211-1 to 211-3 have the same configuration as the light emitters 111-1 and 111-2 of the first example embodiment. The light emitter 211-1 is associated with the optical system 212-1. The light emitter 211-2 is associated with the optical system 212-2. The light emitter 211-3 is associated with the optical system 212-3. The three beams (spatial light signals) derived from the light emitted from the light emitter 211-1, the light emitter 211-2, and the light emitter 211-3 are transmitted toward the same communication target. Therefore, the light emitted from the light emitter 211-1, the light emitter 211-2, and the light emitter 211-3 have the same modulation.

The light emitters 211-1 to 211-3 emit laser light in a predetermined wavelength band under the control of the control unit 28. The optical system 212-1 is arranged in association with the light emitter 211-1. The optical system 212-2 is arranged in association with the light emitter 211-2. The optical system 212-3 is arranged in association with the light emitter 211-3. The optical system 212-1 converts the laser light emitted from the light emitter 211-1 into illumination light 201-1. The optical system 212-2 converts the laser light emitted from the light emitter 211-2 into illumination light 201-2. The optical system 212-3 converts the laser light emitted from the light emitter 211-3 into illumination light 201-3. The converted illumination light beams 201-1 and 201-2 are emitted from the light source 21. The illumination light beams 201-1 to 201-3 travel toward the modulation part 220 of the spatial light modulator 22.

The spatial light modulator 22 has the same configuration as the spatial light modulator 12 of the first example embodiment. The spatial light modulator 22 includes a modulation part 220 that modulates the emitted illumination light 201. The spatial light modulator 22 of the present example embodiment includes a reflection-type modulation part 220. At least one modulation region is set in the modulation part 220. Modulation unit 220 in which the modulation region is set is irradiated with the illumination light 201 emitted from the light source.

In the modulation region set in the modulation part 220, a pattern (phase image) corresponding to the image displayed by projection lights 205 to 207 is set according to the control of the control unit 28. The illumination light 201 incident on the modulation region set in the modulation part 220 is modulated according to the pattern (phase image) set in the modulation region. The modulated light 202 modulated in the modulation region includes projection light 205, the projection light 206, or light (desired light) projected as the projection light 207. The modulated light 202 travels toward the reflecting surface 250 of the first mirror 25, the reflecting surface 260 of the second mirror 26, or the reflecting surface 270 of the third mirror 27. The modulated light 202 also includes an unnecessary light component such as 0th-order light L₀. The 0th-order light L₀ travels toward a region (dead region) between the first mirror 25 and the second mirror 26.

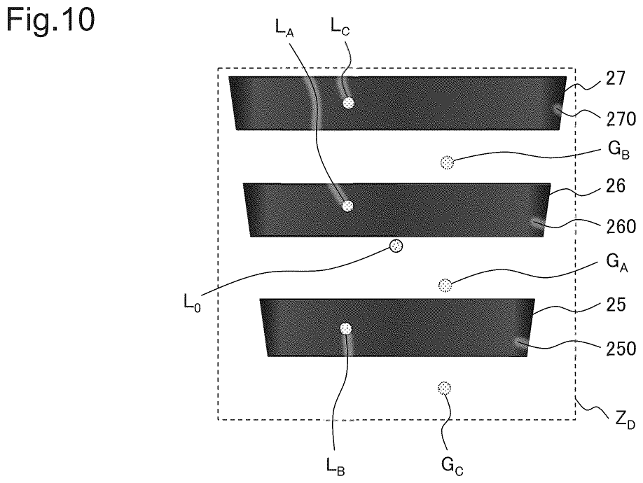

FIG. 10 is a conceptual diagram illustrating a positional relationship among the first mirror 25, the second mirror 26, and the third mirror 27. FIG. 10 is a conceptual diagram of the first mirror 25, the second mirror 26, and the third mirror 27 as viewed from the reflecting surface side. The first mirror 25 has a reflecting surface 250. The second mirror 26 has a reflecting surface 260. The third mirror 27 has a reflecting surface 270. FIG. 10 illustrates an example in which the second mirror 26 and the third mirror 27 are disposed above the first mirror 25. The positions of the first mirror 25, the second mirror 26, and the third mirror 27 may be arbitrarily exchanged. FIG. 10 illustrates a region (dead region Z_{D}) where the modulated light 202 is not reflected around the first mirror 25, the second mirror 26, and the third mirror 27. With respect to the region around the first mirror 25, the second mirror 26, and the third mirror 27, a region not illustrated as the dead region Z_{D} is also included in the dead region Z_{D}.

FIG. 10 illustrates an example of positions irradiated with the 0th-order light L₀, the desired light L_{A}, the desired light L_{B}, the desired light L_{C}, the ghost image G_{A}, the ghost image G_{B}, and the ghost image G_{C}. The 0th-order light L₀ is 0th-order diffracted light included in the modulated light 202. The desired light L_{A}, the desired light L_{B}, and the desired light L_{C} are first-order diffracted light included in the modulated light 202. The desired light L_{A}, the desired light L_{B}, and the desired light L_{C} are light to be projected. The ghost image G_{A} is light that appears at a point-symmetrical position with respect to the desired light L_{A} with the 0th-order light L₀ as the center. The ghost image G_{B} is light that appears at a point-symmetrical position with respect to the desired light L_{B} with the 0th-order light L₀ as the center. The ghost image G_{C} is light that appears at a point-symmetrical position with respect to the desired light L_{C} with the 0th-order light L₀ as the center. The ghost image G_{A}, the ghost image G_{B}, and the ghost image G_{C} are unnecessary light components. Although not illustrated in FIG. 10, the modulated light 202 includes second-order or higher diffracted light (high-order light).

In FIG. 10, the desired light L_{A} is emitted to the reflecting surface 260 of the second mirror 26. The desired light L_{A} emitted to the reflecting surface 260 is projected at a projection angle corresponding to the curvature of the reflecting surface 260. The desired light L_{B} is emitted to the reflecting surface 250 of the first mirror 25. The desired light L_{B} emitted to the reflecting surface 250 is projected at a projection angle corresponding to the curvature of the reflecting surface 250. The reflecting surface 270 of the third mirror 27 is irradiated with the desired light L_{C}. The desired light L_{C} emitted to the reflecting surface 270 is projected at a projection angle corresponding to the curvature of the reflecting surface 270. The 0th-order light L₀ is emitted to the dead region Z_{D} near the second mirror 26. The dead region Z_{D} is irradiated with the ghost image G_{A} of the desired light L_{A}, the ghost image G_{B} of the desired light L_{B}, and the ghost image G_{C} of the desired light L_{C}.

The ghost image G of the desired light L appears at a point-symmetrical position of the desired light L with the 0th-order light L₀ as the center. The first mirror 25, the second mirror 26, and the third mirror are arranged while avoiding a region where the ghost image G is displayed. With such an arrangement, the 0th-order light L₀, the ghost image G_{A}, the ghost image G_{B}, and the ghost image G_{C} are not emitted to the reflecting surface 250, the reflecting surface 260, and the reflecting surface 270. In addition, the high-order light included in the modulated light 202 is emitted to the dead region Z_{D} deviated from the region illustrated in FIG. 10. Therefore, the 0th-order light L₀, the ghost image G_{A}, the ghost image G_{B}, the ghost image G_{C}, and the high-order light are not projected to the outside.

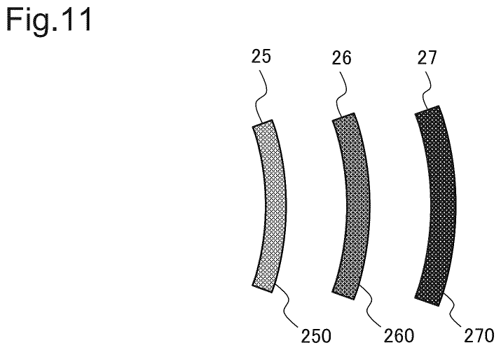

FIG. 11 is a conceptual diagram illustrating a positional relationship among the first mirror 25, the second mirror 26, and the third mirror 27. FIG. 11 is a cross-sectional view of the first mirror 25, the second mirror 26, and the third mirror 27 as viewed from above. In the plane of drawing of FIG. 11, the reflecting surface 250 of the first mirror 25, the reflecting surface 260 of the second mirror 26, and the reflecting surface 270 of the third mirror 27 are directed rightward. FIG. 11 illustrates an example in which the second mirror 26 is disposed in front of the first mirror 25 and the third mirror 27 is disposed in front of the second mirror 26. The order in which the first mirror 25, the second mirror 26, and the third mirror 27 are disposed can be arbitrarily set. For example, the second mirror 26 may be disposed behind the first mirror 25, and the third mirror 27 may be disposed behind the second mirror 26.

The first mirror 25 has the same configuration as the first mirror 15 of the first example embodiment. The first mirror 25 has a curved reflecting surface 250. The convex surface of the first mirror 25 is the reflecting surface 250. The reflecting surface 250 has a curvature corresponding to a projection angle of the projection light 205. The first mirror 25 is disposed with the reflecting surface 250 facing the modulation part 220 of the spatial light modulator 22. The first mirror 25 is disposed on an optical path (first optical path) of the modulated light 202 modulated by the modulation part 220. The first mirror 25 is disposed while avoiding a position irradiated with an unnecessary light component (unnecessary light) included in the modulated light 202. The reflecting surface 250 is irradiated with light to be projected (desired light) in the modulated light 202. The modulated light 202 emitted to the reflecting surface 250 is reflected by the reflecting surface 250. The desired light reflected by the reflecting surface 250 is projected as the projection light 205. The projection light 205 is enlarged at an enlargement ratio corresponding to the curvature of the reflecting surface 250.

The second mirror 26 has the same configuration as the second mirror 16 of the first example embodiment. The second mirror 26 is a curved mirror having a curved reflecting surface 260. The convex surface of the second mirror 26 is the reflecting surface 260. The reflecting surface 260 has a curvature corresponding to a projection angle of the projection light 206. The second mirror 26 is disposed with the reflecting surface 260 facing the modulation part 220 of the spatial light modulator 22. The second mirror 26 is disposed on the optical path (second optical path) of the modulated light 202 modulated by the modulation part 220. The second mirror 26 is disposed while avoiding a position irradiated with unnecessary light included in the modulated light 202. The reflecting surface 260 is irradiated with desired light of the modulated light 202. The modulated light 202 emitted to the reflecting surface 260 is reflected by the reflecting surface 260. The desired light reflected by the reflecting surface 260 is enlarged at an enlargement ratio corresponding to the curvature of the reflecting surface 260 and projected as the projection light 206.

The third mirror 27 is a curved mirror having a curved reflecting surface 270. The convex surface of the third mirror 27 is the reflecting surface 270. The reflecting surface 270 has a curvature corresponding to a projection angle of the projection light 207. The third mirror 27 is disposed with the reflecting surface 270 facing the modulation part 220 of the spatial light modulator 22. The third mirror 27 is disposed on the optical path (third optical path) of the modulated light 202 modulated by the modulation part 220. The third mirror 27 is disposed while avoiding a position irradiated with unnecessary light included in the modulated light 202. The reflecting surface 270 is irradiated with desired light of the modulated light 202. The modulated light 202 emitted to the reflecting surface 270 is reflected by the reflecting surface 270. The desired light reflected by the reflecting surface 270 is enlarged at an enlargement ratio corresponding to the curvature of the reflecting surface 270 and projected as the projection light 207.

The projection lights 205 to 207 are transmitted as a spatial light signal through a slit (not illustrated) opened in a housing of the transmission device 20. The projection lights 205 to 207 spread as they go away from the transmission device 20. In the distance reaching the communication target, the projection range of the projection lights 205 to 207 is substantially the same. For example, a lens (not illustrated) may be disposed at a subsequent stage of the first mirror 25, the second mirror 26, and the third mirror 27. The lens is arranged to limit the spread of the projection lights 205 to 207 or to enlarge the spread of the projection lights 205 to 207. The structure and shape of the lens may be determined according to the application.

The control unit 28 has the same configuration as the control unit 18 of the first example embodiment. The control unit 28 controls the light source 21 and the spatial light modulator 22. For example, the control unit 28 is achieved by a microcomputer including a processor and a memory. The control unit 28 sets a phase image corresponding to the projected image in the modulation part 220 in accordance with the aspect ratio of tiling set in the modulation part 220 of the spatial light modulator 22. The control unit 28 sets a phase image corresponding to the projected image in the modulation region set in the modulation part 220 of the spatial light modulator 22.

The control unit 28 drives the light source 21 in a state where the phase image corresponding to the image to be displayed is set in the modulation part 220. As a result, the illumination light 201 emitted from the light source 21 is emitted to the modulation part 220 of the spatial light modulator 22 in accordance with the timing at which the phase image is set in the modulation part 220 of the spatial light modulator 22. The illumination light 201 emitted to the modulation part 220 of the spatial light modulator 22 is modulated by the modulation part 220 of the spatial light modulator 22. The modulated light 202 modulated by the modulation part 220 is emitted toward the first mirror 25, the second mirror 26, and the third mirror 27.

Furthermore, the control unit 28 modulates the illumination light 201 emitted from the light source 21 for communication with a communication target (not illustrated). In communication, the control unit 28 controls the timing at which the illumination light 201 is emitted from the light source 21 in a state where the phase image for communication is set in the modulation part 220 of the spatial light modulator 22. By such control, the illumination light 201 is modulated. The modulation pattern of the illumination light 201 in the communication is arbitrarily set. For example, a configuration for communication (communication unit) may be added separately from the control unit 28. In that case, the control unit 28 may be configured to control the light source 21 and the spatial light modulator 22 according to the condition set by the communication unit.

The transmission device 20 of the present example embodiment transmits a spatial light signal (projection lights 205 to 207) based on the light emitted from the three light emitters 211-1 to 211-3 included in the light source 21. The number of beams of the spatial light signal is larger in the present example embodiment than in the first example embodiment. Therefore, compared with the first example embodiment, in the present example embodiment, the spatial light signal immediately after transmission from the transmission device 20 is less likely to be affected by rain drops or the like.

As described above, the transmission device according to the present example embodiment includes a light source, a spatial light modulator, a first mirror, a second mirror, a third mirror, and a control unit. The light source includes a first light emitter, a second light emitter, and a third light emitter. The spatial light modulator includes a modulation part that modulates the light emitted from the light source. The first mirror has a convex curved reflecting surface. The first mirror is disposed on the first optical path of the modulated light modulated by the modulation part. The first mirror is disposed with the reflecting surface facing the first projection direction. The reflecting surface of the first mirror reflects the modulated light in the first projection direction. The second mirror has a convex curved reflecting surface. The second mirror is disposed on the second optical path of the modulated light modulated by the modulation part. The second mirror is disposed with the reflecting surface facing the first projection direction. The reflecting surface of the second mirror reflects the modulated light in the first projection direction. The third mirror has a convex curved reflecting surface. The third mirror is disposed on the third optical path of the modulated light modulated by the modulation part. The third mirror is disposed with the reflecting surface facing the first projection direction. The reflecting surface of the third mirror reflects the modulated light in the first projection direction. The control unit sets the phase image used for the spatial light communication in the modulation part of the spatial light modulator included in the transmitter. The control unit controls a light source included in the transmitter so that the modulation part is irradiated with light.

In the present example embodiment, the beams of the spatial light signal (projection light) are separated into three by reflecting the illumination light derived from the light emitted from the three light emitters by the three reflecting surfaces. According to the present example embodiment, multiple beams configured by three beams are transmitted as spatial light signals (projection light). According to the present example embodiment, by forming the spatial light signal (projection light) into three multiple beams, it is possible to realize continuous optical spatial communication which is less affected by the weather than the first example embodiment.

### Third Example Embodiment

Next, a transmission device according to a third example embodiment will be described with reference to the drawings. The first mirror of the transmission device of the present example embodiment includes two mirrors in which two curved surfaces are combined. The mirror of the present example embodiment may be applied to the second example embodiment.

(Configuration)

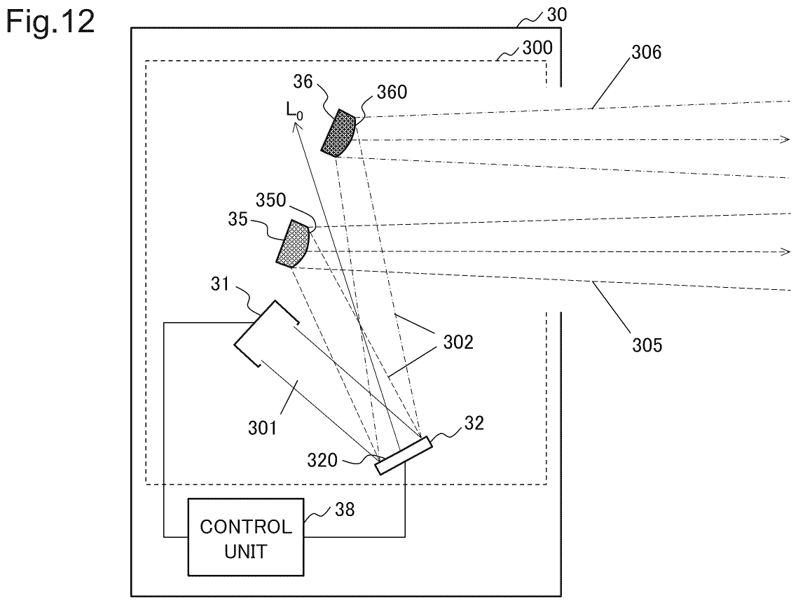

FIG. 12 is a conceptual diagram illustrating an example of a configuration of a transmission device 30 according to the present example embodiment. The transmission device 30 includes a light source 31, a spatial light modulator 32, a first mirror 35, a second mirror 36, and a control unit 38. The light source 31, the spatial light modulator 32, the first mirror 35, and the second mirror 36 constitute a transmitter 300. FIG. 12 is a conceptual diagram of the internal configuration of the transmission device 30 as viewed from the lateral direction. FIG. 12 is conceptual, and does not accurately represent the shape of each component, the positional relationship between components, the travel of light, and the like.

The light source 31 has four light emitters (first light emitter, second light emitter, third light emitter, and fourth light emitter). One optical system is disposed in each of the four light emitters. That is, the light source 31 includes four sets of a light emitter and an optical system. For example, the light source 31 has a structure in which four light emitters are arranged in a row. For example, the light source 31 has a structure in which four light emitters are arranged in two rows and two columns. Details of the structure of the light source 31 will be omitted. The light source 31 has an emission surface from which the illumination light 301 is emitted. The emission surface of the light source 31 is directed to the spatial light modulator 32. The light source 31 emits illumination light 301 toward the modulation part 320 of the spatial light modulator 22 under the control of the control unit 38. The illumination light 301 includes four beams.

The spatial light modulator 32 has the same configuration as the spatial light modulator 12 of the first example embodiment. The spatial light modulator 32 includes a modulation part 320 that modulates the emitted light. The spatial light modulator 32 of the present example embodiment includes a reflection-type modulation part 320. The modulation region of the modulation part 320 is irradiated with the illumination light 301 emitted from the light source 31.

In the modulation region set in the modulation part 320, a pattern (phase image) corresponding to the image displayed by projection lights 305 to 306 is set according to the control of the control unit 38. The modulation region may be set for each reflecting surface or may be common to a plurality of reflecting surfaces. The illumination light 301 incident on the modulation region is modulated according to a pattern (phase image) set in the modulation region. The modulated light 302 modulated in the modulation region includes projection light 305 or light (desired light) projected as the projection light 306. The modulated light 302 also includes an unnecessary light component such as 0th-order light L₀. The 0th-order light L₀ travels toward a region (dead region) between the first mirror 35 and the second mirror 36. The modulated light 302 modulated in the modulation region travels toward the first mirror 35 and the second mirror 36 disposed at a subsequent stage. In the example of FIG. 12, the first mirror 35 and the second mirror 36 are arranged at a subsequent stage of the spatial light modulator 32. As described later, the first mirror 35 and the second mirror 36 have two reflecting surfaces.

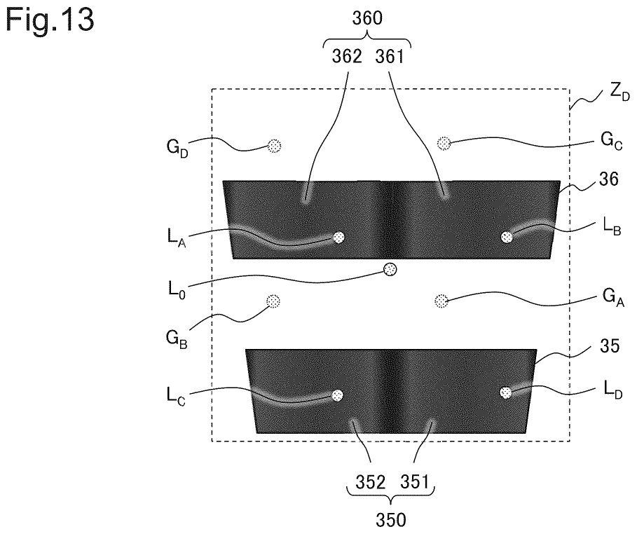

FIG. 13 is a conceptual diagram illustrating a positional relationship between the first mirror 35 and the second mirror 36. FIG. 13 is a conceptual diagram of the first mirror 35 and the second mirror 36 as viewed from the reflecting surface side. The reflecting surface 350 of the first mirror 35 includes a reflecting surface 351 and a reflecting surface 352. Each of the reflecting surface 351 and the reflecting surface 352 is a convex reflecting surface. The reflecting surface 360 of the second mirror 36 includes the reflecting surface 361 and the reflecting surface 362. Each of the reflecting surface 361 and the reflecting surface 362 is a convex reflecting surface. FIG. 13 illustrates an example in which the second mirror 36 is disposed above the first mirror 35. The positions of the first mirror 35 and the second mirror 36 may be arbitrarily exchanged. FIG. 13 illustrates a region (dead region Z_{D}) where the modulated light 302 is not reflected around the first mirror 35 and the second mirror 36. With respect to the region around the first mirror 35 and the second mirror 36, a region not illustrated as the dead region Z_{D} is also included in the dead region Z_{D}.

FIG. 13 illustrates an example of positions irradiated with the 0th-order light L₀, the desired light L_{A}, the desired light L_{B}, the desired light L_{C}, the desired light L_{D}, the ghost image G_{A}, the ghost image G_{B}, the ghost image G_{C}, and the ghost image G_{B}. The 0th-order light L₀ is 0th-order diffracted light included in the modulated light 302. The desired light L_{A}, the desired light L_{B}, the desired light L_{C}, and the desired light L D are first-order diffracted light included in the modulated light 302. The desired light L_{A}, the desired light L_{B}, the desired light L_{C}, and the desired light L D are light to be projected. The ghost image G_{A} is light that appears at a point-symmetrical position with respect to the desired light L_{A} with the 0th-order light L₀ as the center. The ghost image G_{B} is light that appears at a point-symmetrical position with respect to the desired light L_{B} with the 0th-order light L₀ as the center. The ghost image G_{C} is light that appears at a point-symmetrical position with respect to the desired light L_{C} with the 0th-order light L₀ as the center. The ghost image G_{D} is light appearing at a point-symmetrical position with respect to the desired light L D with the 0th-order light L₀ as the center. The ghost image G_{A}, the ghost image G_{B}, the ghost image G_{C}, and the ghost image G_{D} are unnecessary light components. Note that, although not illustrated in FIG. 13, the modulated light 302 includes second-order or higher diffracted light (high-order light).

In FIG. 13, the desired light L_{A} is emitted to the reflecting surface 362 of the second mirror 36. The desired light L_{A} emitted to the reflecting surface 362 is projected at a projection angle corresponding to the curvature of the reflecting surface 362. The desired light L_{B} is emitted to the reflecting surface 361 of the second mirror 36. The desired light L_{B} emitted to the reflecting surface 361 is projected at a projection angle corresponding to the curvature of the reflecting surface 361. The reflecting surface 352 of the first mirror 35 is irradiated with the desired light L_{C}. The desired light L_{C} emitted to the reflecting surface 352 is projected at a projection angle corresponding to the curvature of the reflecting surface 352. The desired light L_{D} is emitted to the reflecting surface 351 of the first mirror 35. The desired light L_{D} emitted to the reflecting surface 351 is projected at a projection angle corresponding to an incident angle with respect to the reflecting surface 351. The 0th-order light L₀ is emitted to the dead region Z_{D} near the second mirror 36. The dead region Z_{D} is irradiated with the ghost image G_{A} of the desired light L_{A}, the ghost image G_{B} of the desired light L_{B}, the ghost image G_{C} of the desired light L_{C}, and the ghost image G_{D} of the desired light L_{D}.

The ghost image G of the desired light L appears at a point-symmetrical position of the desired light L with the 0th-order light L₀ as the center. Therefore, the first mirror and the second mirror 36 are arranged while avoiding a region where the ghost image G is displayed. With such a configuration, the 0th-order light L₀, the ghost image G_{A}, the ghost image G_{B}, the ghost image G_{C}, and the ghost image G_{D} are not irradiated to the reflecting surface 351, the reflecting surface 352, the reflecting surface 361, and the reflecting surface 362. In addition, the high-order light included in the modulated light 302 is emitted to the dead region outside the region illustrated in FIG. 13. Therefore, the 0th-order light L₀, the ghost image G_{A}, the ghost image G_{B}, the ghost image G_{C}, the ghost image G_{D}, and the high-order light are not projected to the outside.

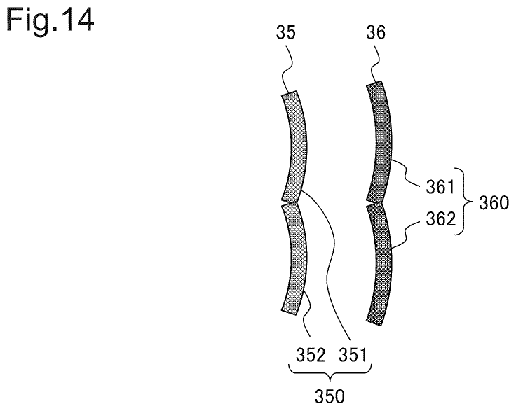

FIG. 14 is a conceptual diagram illustrating a positional relationship between the first mirror 35 and the second mirror 36. FIG. 14 is a cross-sectional view of the first mirror 35 and the second mirror 36 as viewed from above. In the plane of drawing of FIG. 14, the reflecting surface 350 (the reflecting surface 351, the reflecting surface 352) of the first mirror 35 is directed rightward. Similarly, the reflecting surface 360 (the reflecting surface 361, the reflecting surface 362) of the second mirror 36 is directed rightward.

The first mirror 35 is a curved mirror having a curved reflecting surface 350. The reflecting surface 350 includes two reflecting surfaces (the reflecting surface 351 and the reflecting surface 352). Two convex surfaces of the first mirror 35 are reflecting surface 351 and the reflecting surface 352. The reflecting surface 351 and the reflecting surface 352 have curvatures corresponding to projection angles of the projection light 305.

The first mirror 35 is disposed with the reflecting surface 350 (the reflecting surface 351, the reflecting surface 352) facing the modulation part 320 of the spatial light modulator 32. The first mirror 35 is disposed on the optical path (first optical path) of the modulated light 302 modulated in the modulation region set in the modulation part 320. The first mirror 35 is disposed while avoiding a position irradiated with unnecessary light included in the modulated light 302. The reflecting surface 350 (the reflecting surface 351, the reflecting surface 352) is irradiated with desired light of the modulated light 302. The modulated light 302 emitted to the reflecting surface 350 is reflected by the reflecting surface 351 or the reflecting surface 352. The desired light reflected by the reflecting surface 350 is projected as the projection light 305. The projection light 305 is enlarged at an enlargement factor corresponding to the curvature of the reflecting surface 350 (the reflecting surface 351, the reflecting surface 352).

The second mirror 36 is a curved mirror having a curved reflecting surface 360. The reflecting surface 360 includes two reflecting surfaces (the reflecting surface 361, the reflecting surface 362). The two convex surfaces of the second mirror 36 are reflecting surface 361 and the reflecting surface 362. The reflecting surface 361 and the reflecting surface 362 have curvatures corresponding to projection angles of the projection light 306.

The second mirror 36 is disposed with the reflecting surface 360 (the reflecting surface 361, the reflecting surface 362) facing the modulation part 320 of the spatial light modulator 32. The second mirror 36 is disposed on the optical path (second optical path) of the modulated light 302 modulated in the modulation region set in the modulation part 320. The second mirror 36 is disposed while avoiding a position irradiated with unnecessary light included in the modulated light 302. The reflecting surface 360 (the reflecting surface 361, the reflecting surface 362) is irradiated with desired light of the modulated light 302. The modulated light 302 emitted to the reflecting surface 360 is reflected by the reflecting surface 361 or the reflecting surface 362. The desired light reflected by the reflecting surface 360 is projected as the projection light 306. The projection light 306 is enlarged at an enlargement factor corresponding to the curvature of the reflecting surface 360 (the reflecting surface 361, the reflecting surface 362).

The shapes of the reflecting surface 351, the reflecting surface 352, the reflecting surface 361, and the reflecting surface 362 are not limited as long as they include curved portions. For example, the reflecting surface 351, the reflecting surface 352, the reflecting surface 361, and the reflecting surface 362 have the shape of a side surface of a cylinder. For example, the reflecting surface 351, the reflecting surface 352, the reflecting surface 361, and the reflecting surface 362 may be a free-form surface or a spherical surface. For example, the reflecting surface 351, the reflecting surface 352, the reflecting surface 361, and the reflecting surface 362 may have a shape obtained by combining a plurality of curved surfaces. For example, the reflecting surface 351, the reflecting surface 352, the reflecting surface 361, and the reflecting surface 362 may have a shape obtained by combining a curved surface and a flat surface.

The projection light 305 and the projection light 306 are transmitted as a spatial light signal through a slit (not illustrated) opened in a housing of the transmission device 30. The projection light 305 and the projection light 306 spread as they go away from the transmission device 30. In the distance reaching the communication target, the projection range of the projection lights 305 to 306 is substantially the same. For example, a lens (not illustrated) for limiting the spread of the projection light 305 and the projection light 306 or enlarging the spread of the projection light 305 and the projection light 306 may be disposed at the subsequent stage of the first mirror 35 and the second mirror 36.

The control unit 38 has the same configuration as the control unit 18 of the first example embodiment. The control unit 38 controls the light source 31 and the spatial light modulator 32. For example, the control unit 38 is achieved by a microcomputer including a processor and a memory. The control unit 38 sets a phase image corresponding to the projected image in the modulation part 320 in accordance with the aspect ratio of tiling set in the modulation part 320 of the spatial light modulator 32. The control unit 38 sets a phase image corresponding to the projected image in the modulation region set in the modulation part 320 of the spatial light modulator 32. For example, the control unit 38 sets, in the modulation part 320, a phase image corresponding to an image according to a use such as image display, communication, or distance measurement. The phase image of the projected image may be stored in advance in a storage unit (not illustrated). The shape and size of the image to be projected are not particularly limited.

The control unit 38 drives the light source 31 in a state where the phase image corresponding to the image to be displayed is set in the modulation part 320. As a result, the illumination light 301 emitted from the light source 31 is emitted to the modulation part 320 of the spatial light modulator 32 in accordance with the timing at which the phase image is set in the modulation part 320 of the spatial light modulator 32. The illumination light 301 emitted to the modulation part 320 of the spatial light modulator 32 is modulated by the modulation part 320 of the spatial light modulator 32. The modulated light 302 modulated by the modulation part 320 is emitted toward the first mirror 35 and the second mirror 36.

Furthermore, the control unit 38 modulates the illumination light 301 emitted from the light source 31 for communication with a communication target (not illustrated). In communication, the control unit 38 controls the timing at which the illumination light 301 is emitted from the light source 31 in a state where the phase image for communication is set in the modulation part 320 of the spatial light modulator 32. By such control, the illumination light 301 is modulated. The modulation pattern of the illumination light 301 in the communication is arbitrarily set. For example, a configuration for communication (communication unit) may be added separately from the control unit 38. In that case, the control unit 38 may be configured to control the light source 31 and the spatial light modulator 32 according to the condition set by the communication unit.

As described above, the transmission device according to the present example embodiment includes the light source, the spatial light modulator, the first mirror, the second mirror, and the control unit. The light source includes a first light emitter, a second light emitter, a third light emitter, and a fourth light emitter. The spatial light modulator includes a modulation part that modulates the light emitted from the light source. The first mirror has two convex curved reflecting surfaces. The first mirror is disposed on the first optical path of the modulated light modulated by the modulation part. The first mirror is disposed with the two reflecting surfaces facing the first projection direction. The second mirror has two convex curved reflecting surfaces. The second mirror is disposed on the second optical path of the modulated light modulated by the modulation part. The second mirror is disposed with the two reflecting surfaces facing the first projection direction. The modulated light derived from the light emitted from the first light emitter, the second light emitter, the third light emitter, and the fourth light emitter is emitted to one of the four reflecting surfaces of the first mirror and the second mirror. The two reflecting surfaces of the first mirror reflect the modulated light in the first projection direction. The two reflecting surfaces of the second mirror reflect the modulated light in the first projection direction. The control unit sets the phase image used for the spatial light communication in the modulation part of the spatial light modulator included in the transmitter. The control unit controls a light source included in the transmitter so that the modulation part is irradiated with light.

In the present example embodiment, the beams of the spatial light signal (projection light) are separated into four beams by reflecting the illumination light derived from the light emitted from the four light emitters by the four reflecting surfaces. According to the present example embodiment, multiple beams configured by four beams are transmitted as spatial light signals (projection light). According to the present example embodiment, by forming the spatial light signal (projection light) into four multiple beams, it is possible to realize continuous optical spatial communication which is less affected by the weather than the first to second example embodiments.

### Fourth Example Embodiment

Next, a transmission device according to a fourth example embodiment will be described with reference to the drawings. The transmission device of the present example embodiment is an example in which the light source of the first example embodiment is replaced with the light source of the third example embodiment.

(Configuration)

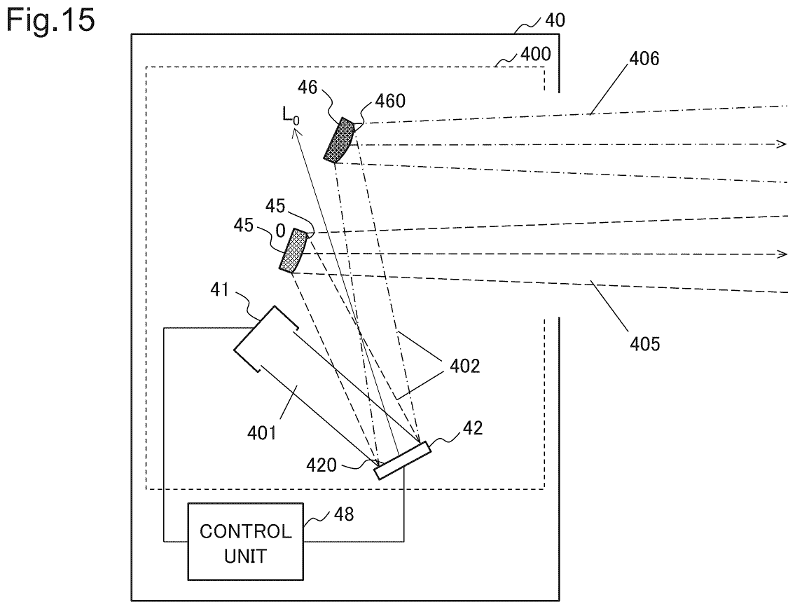

FIG. 15 is a conceptual diagram illustrating an example of a configuration of a communication device 40 according to the present example embodiment. The transmission device 40 includes a light source 41, a spatial light modulator 42, a first mirror 45, a second mirror 46, and a control unit 48. The light source 41, the spatial light modulator 42, the first mirror 45, and the second mirror 46 constitute a transmitter 400. FIG. 15 is a conceptual diagram of the internal configuration of the transmission device 40 as viewed from the lateral direction. FIG. 15 is conceptual, and does not accurately represent the shape of each component, the positional relationship between components, the travel of light, and the like.

The light source 41 has the same configuration as the light source 31 of the third example embodiment. The light source 41 has four light emitters (first light emitter, second light emitter, third light emitter, and fourth light emitter). One optical system is disposed in each of the four light emitters. That is, the light source 41 includes four sets of a light emitter and an optical system. The light source 41 has an emission surface from which the illumination light 401 is emitted. The emission surface of the light source 41 is directed to the spatial light modulator 42. The light source 41 emits illumination light 401 toward the modulation part 420 of the spatial light modulator 42 under the control of the control unit 48. The illumination light 401 includes four beams.

The spatial light modulator 42 has the same configuration as the spatial light modulator 12 of the first example embodiment. The spatial light modulator 42 includes a modulation part 420 that modulates the emitted light. The spatial light modulator 42 of the present example embodiment includes a reflection-type modulation part 420. The modulation region of the modulation part 420 is irradiated with the illumination light 401 emitted from the light source 41.

In the modulation region set in the modulation part 420, a pattern (phase image) corresponding to the image displayed by the projection lights 405 to 406 is set according to the control of the control unit 48. The modulation region may be set for each reflecting surface or may be common to a plurality of reflecting surfaces. The illumination light 401 incident on the modulation region is modulated according to a pattern (phase image) set in the modulation region. The modulated light 402 modulated in the modulation region includes projection light 405 or light (desired light) projected as the projection light 406. The modulated light 402 also includes an unnecessary light component such as 0th-order light L₀. The 0th-order light L₀ travels toward a region (dead region) between the first mirror 45 and the second mirror 46. The modulated light 402 modulated in the modulation region travels toward the first mirror 45 or the second mirror 46 disposed at a subsequent stage. As described later, the first mirror 45 and the second mirror 46 have two reflecting surfaces.

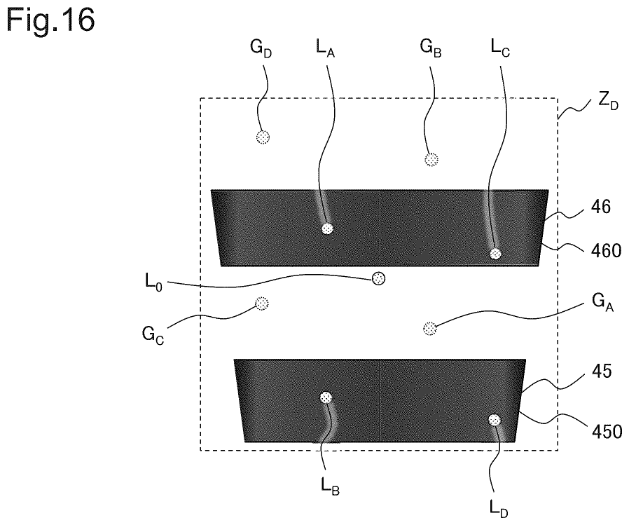

FIG. 16 is a conceptual diagram illustrating a positional relationship between the first mirror 45 and the second mirror 46. FIG. 16 is a conceptual diagram of the first mirror 45 and the second mirror 46 as viewed from the reflecting surface side. The reflecting surface 450 of the first mirror 45 and the reflecting surface 460 of the second mirror 46 are convex reflecting surfaces. FIG. 16 illustrates a region (dead region Z_{D}) where the modulated light 402 is not reflected around the first mirror 45 and the second mirror 46.

FIG. 16 illustrates an example of positions irradiated with the 0th-order light L₀, the desired light L_{A}, the desired light L_{B}, the desired light L_{C}, the desired light L_{D}, the ghost image G_{A}, the ghost image G_{B}, the ghost image G_{C}, and the ghost image G_{D}. The 0th-order light L₀ is 0th-order diffracted light included in the modulated light 402. The desired light L_{A} and the desired light L_{B} are first-order diffracted light included in the modulated light 402. The desired light L_{A}, the desired light L_{B}, the desired light L_{C}, and the desired light L_{D} are light to be projected. The ghost image G_{A} is light that appears at a point-symmetrical position with respect to the desired light L_{A} with the 0th-order light L₀ as the center. The ghost image G_{B} is light that appears at a point-symmetrical position with respect to the desired light L_{B} with the 0th-order light L₀ as the center. The ghost image G_{C} is light that appears at a point-symmetrical position with respect to the desired light L_{C} with the 0th-order light L₀ as the center. The ghost image G_{D} is light appearing at a point-symmetrical position with respect to the desired light L_{D} with the 0th-order light L₀ as the center. The ghost image G_{A}, the ghost image G_{B}, the ghost image G_{C}, and the ghost image G_{D} are unnecessary light components. Note that, although not illustrated in FIG. 16, the modulated light 402 includes second-order or higher diffracted light (high-order light).

In FIG. 16, the desired light L_{A} is emitted to the reflecting surface 460 of the second mirror 46. The desired light L_{A} emitted to the reflecting surface 460 is projected at a projection angle corresponding to the curvature of the reflecting surface 460. The desired light L_{B} is emitted to the reflecting surface 450 of the first mirror 45. The desired light L_{B} emitted to the reflecting surface 450 is projected at a projection angle corresponding to the curvature of the reflecting surface 450. The reflecting surface 450 of the first mirror 45 is irradiated with the desired light L_{C}. The desired light L_{C} emitted to the reflecting surface 450 is projected at a projection angle corresponding to the curvature of the reflecting surface 450. The reflecting surface 460 of the second mirror 46 is irradiated with the desired light L_{D}. The desired light L_{D} emitted to the reflecting surface 460 is projected at a projection angle corresponding to an incident angle with respect to the reflecting surface 460. The 0th-order light L₀ is emitted to the dead region ZD near the second mirror 46. The dead region Z_{D} is irradiated with the ghost image G_{A} of the desired light L_{A}, the ghost image G_{B} of the desired light L_{B}, the ghost image G_{C} of the desired light L_{C}, and the ghost image G_{D} of the desired light L_{D}.

The ghost image G of the desired light L appears at a point-symmetrical position of the desired light L with the 0th-order light L₀ as the center. Therefore, the first mirror and the second mirror 46 are arranged while avoiding a region where the ghost image G is displayed. With such a configuration, the reflecting surface 450 and the reflecting surface 460 are not irradiated with the 0th-order light L₀, the ghost image G_{A}, the ghost image G_{B}, the ghost image G_{C}, and the ghost image G_{D}. In addition, the high-order light included in the modulated light 402 is emitted to the dead region outside the region illustrated in FIG. 16. Therefore, the 0th-order light L₀, the ghost image G_{A}, the ghost image G_{B}, the ghost image G_{C}, the ghost image G_{D}, and the high-order light are not projected to the outside.

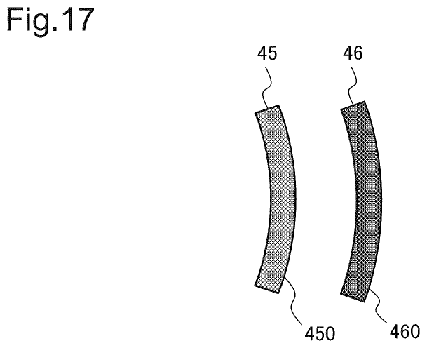

FIG. 17 is a conceptual diagram illustrating a positional relationship between the first mirror 45 and the second mirror 46. FIG. 17 is a cross-sectional view of the first mirror 45 and the second mirror 46 as viewed from above. In the plane of drawing of FIG. 17, the reflecting surface 450 of the first mirror 45 is directed rightward. Similarly, the reflecting surface 460 of the second mirror 46 is directed rightward.

The first mirror 45 is a curved mirror having a curved reflecting surface 450. The concave surface of the first mirror 45 is the reflecting surface 450. The reflecting surface 450 has a curvature corresponding to a projection angle of the projection light 405. The shape of the reflecting surface 450 is not limited as long as it includes a curved portion. For example, the reflecting surface 450 has the shape of a side surface of a cylinder. For example, the reflecting surface 450 may be a free-form surface or a spherical surface. For example, the reflecting surface 450 may have a shape obtained by combining a plurality of curved surfaces. For example, the reflecting surface 450 may have a shape obtained by combining a curved surface and a flat surface.

The first mirror 45 is disposed with the reflecting surface 450 facing the modulation part 420 of the spatial light modulator 42. The first mirror 45 is disposed on an optical path (first optical path) of the modulated light 402 modulated by the modulation part 420. The first mirror 45 is disposed while avoiding a position irradiated with an unnecessary light component (unnecessary light) included in the modulated light 402. The reflecting surface 450 is irradiated with light to be projected (desired light) in the modulated light 402. The modulated light 402 emitted to the reflecting surface 450 is reflected by the reflecting surface 450. The desired light reflected by the reflecting surface 450 is projected as the projection light 405.

The second mirror 46 is a curved mirror having a curved reflecting surface 460. The convex surface of the second mirror 46 is the reflecting surface 460. The reflecting surface 460 has a curvature corresponding to a projection angle of the projection light 406. The shape of the reflecting surface 460 is not limited as long as it includes a curved portion. For example, the reflecting surface 460 has the shape of a side surface of a cylinder. For example, the reflecting surface 460 may be a free-form surface or a spherical surface. For example, the reflecting surface 460 may have a shape obtained by combining a plurality of curved surfaces. For example, the reflecting surface 460 may have a shape obtained by combining a curved surface and a flat surface.

The second mirror 46 is disposed with the reflecting surface 460 facing the modulation part 420 of the spatial light modulator 42. The second mirror 46 is disposed on the optical path (second optical path) of the modulated light 402 modulated in the associated modulation region. The second mirror 46 is disposed while avoiding a position irradiated with an unnecessary light component (unnecessary light) included in the modulated light 402. The reflecting surface 460 is irradiated with light to be projected (desired light) in the modulated light 402. The modulated light 402 emitted to the reflecting surface 460 is reflected by the reflecting surface 460. The desired light reflected by the reflecting surface 460 is enlarged at an enlargement ratio corresponding to the curvature of the reflecting surface 460 and projected as the projection light 406.

The projection light 405 and the projection light 406 are transmitted as a spatial light signal through a slit (not illustrated) opened in a housing of the transmission device 40. The projection light 405 and the projection light 406 spread as they go away from the transmission device 40. In the distance reaching the communication target, the projection range of the projection lights 405 to 406 is substantially the same. For example, a lens (not illustrated) for limiting the spread of the projection lights 405 to 406 or enlarging the spread of the projection lights 405 to 406 may be disposed at the subsequent stage of the first mirror 45 and the second mirror 46.

The control unit 48 has the same configuration as the control unit 18 of the first example embodiment. The control unit 48 controls the light source 41 and the spatial light modulator 42. For example, the control unit 48 is achieved by a microcomputer including a processor and a memory. The control unit 48 sets a phase image corresponding to the projected image in the modulation part 420 in accordance with the aspect ratio of tiling set in the modulation part 420 of the spatial light modulator 42. The control unit 48 sets a phase image corresponding to the projected image in the modulation region set in the modulation part 420 of the spatial light modulator 42. For example, the control unit 48 sets, in the modulation part 420, a phase image corresponding to an image according to a use such as image display, communication, or distance measurement. The phase image of the projected image may be stored in advance in a storage unit (not illustrated). The shape and size of the image to be projected are not particularly limited.

The control unit 48 drives the light source 41 in a state where the phase image corresponding to the image to be displayed is set in the modulation part 420. As a result, the illumination light 401 emitted from the light source 41 is emitted to the modulation part 420 of the spatial light modulator 42 in accordance with the timing at which the phase image is set in the modulation part 420 of the spatial light modulator 42. The illumination light 401 emitted to the modulation part 420 of the spatial light modulator 42 is modulated by the modulation part 420 of the spatial light modulator 42. The modulated light 402 modulated by the modulation part 420 is emitted toward the first mirror 45 and the second mirror 46.

Furthermore, the control unit 48 modulates the illumination light 401 emitted from the light source 41 for communication with a communication target (not illustrated). In communication, the control unit 48 controls the timing at which the illumination light 401 is emitted from the light source 41 in a state where the phase image for communication is set in the modulation part 420 of the spatial light modulator 42. By such control, the illumination light 401 is modulated. The modulation pattern of the illumination light 401 in the communication is arbitrarily set. For example, a configuration for communication (communication unit) may be added separately from the control unit 48. In that case, the control unit 48 may be configured to control the light source 41 and the spatial light modulator 42 according to the condition set by the communication unit.

In the present example embodiment, the beams of the spatial light signal (projection light) are separated into four by reflecting the illumination light derived from the illumination light emitted from the four light emitters by the two reflecting surfaces. As a result, according to the present example embodiment, multiple beams including four beams are transmitted as a spatial light signal (projection light). According to the present example embodiment, by forming the spatial light signal (projection light) into four multiple beams, the spatial light signal is less likely to be affected by the weather such as raindrops than the first to second example embodiments.

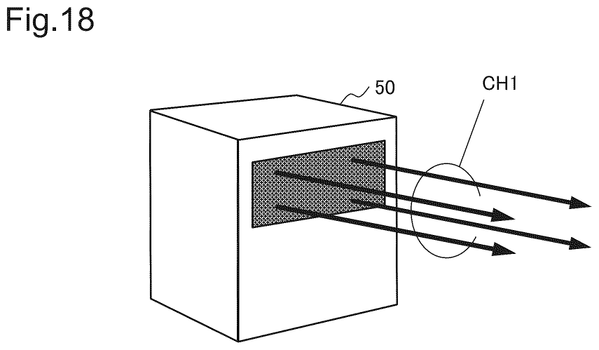

FIGS. 18 to 20 are conceptual diagrams illustrating images of spatial light signals transmitted from the transmission device 40. The examples of FIGS. 18 to 20 illustrate variations in how beams constituting the spatial light signal are allocated. The examples of FIGS. 18 to 20 can also be applied to the spatial light signal transmitted from the transmission device 30 of the third example embodiment.

FIG. 18 illustrates an example in which four beams constituting the spatial light signal are transmitted on one channel (CH1). In the example of FIG. 18, spatial light signals configured by four beams are used to communicate with a single communication target. According to the example of FIG. 18, using the spatial light signal configured by multiple beams including four beams, it is possible to further reduce the interruption of communication due to the influence of raindrops or the like as compared with the first to second example embodiments using multiple beams including two to three beams.

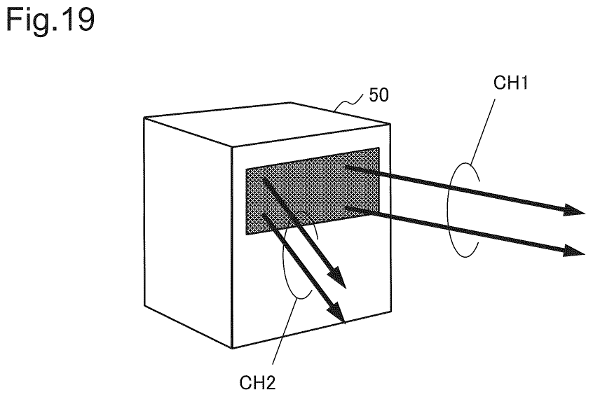

FIG. 19 illustrates an example in which four beams constituting the spatial light signal are transmitted through two channels (CH1, CH2). FIG. 19 illustrates an example in which two beams arranged in the longitudinal direction are combined to form one channel. In the example of FIG. 19, a spatial light signal constituted by four beams is used to communicate with two communication targets. According to the example of FIG. 19, a spatial light signal configured by multiple beams including two beams can be independently transmitted toward two communication targets.

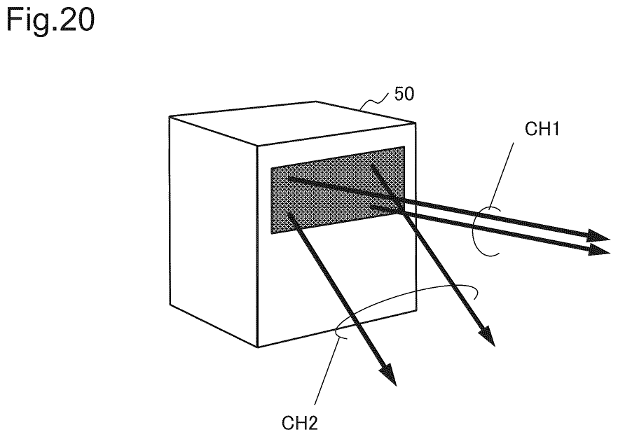

FIG. 20 illustrates an example in which four beams constituting the spatial light signal are transmitted through two channels (CH1, CH2). FIG. 20 illustrates an example in which two beams in an oblique positional relationship are combined by tucking to form one channel. In the example of FIG. 20, a spatial light signal constituted by four beams is used to communicate with two communication targets. According to the example of FIG. 20, a spatial light signal configured by multiple beams including two beams combined by cross bracing can be independently transmitted to two communication targets.

As described above, the transmission device according to the present example embodiment includes the light source, the spatial light modulator, the first mirror, the second mirror, and the control unit. The light source includes a first light emitter, a second light emitter, a third light emitter, and a fourth light emitter. The spatial light modulator includes a modulation part that modulates the light emitted from the light source. The first mirror has a convex curved reflecting surface. The first mirror is disposed on the first optical path of the modulated light modulated by the modulation part. The first mirror is disposed with the reflecting surface facing the first projection direction. The second mirror has a convex curved reflecting surface. The second mirror is disposed on the second optical path of the modulated light modulated by the modulation part. The second mirror is disposed with the reflecting surface facing the first projection direction. The modulated light derived from the light emitted from the first light emitter, the second light emitter, the third light emitter, and the fourth light emitter is emitted to one of the reflecting surfaces of the first mirror and the second mirror. The two reflecting surfaces of the first mirror reflect the modulated light in the first projection direction. The two reflecting surfaces of the second mirror reflect the modulated light in the first projection direction. The control unit sets the phase image used for the spatial light communication in the modulation part of the spatial light modulator included in the transmitter. The control unit controls a light source included in the transmitter so that the modulation part is irradiated with light.

In the present example embodiment, the beams of the spatial light signal (projection light) are separated into four by reflecting the illumination light derived from the light emitted from the four light emitters by the two reflecting surfaces. According to the present example embodiment, multiple beams configured by four beams are transmitted as spatial light signals (projection light). According to the present example embodiment, by forming the spatial light signal (projection light) into four multiple beams, it is possible to realize continuous optical spatial communication which is less affected by the weather than the first to second example embodiments. In addition, according to the present example embodiment, the structure of the mirror is simplified as compared with the third example embodiment.

### Fifth Example Embodiment

Next, a communication device according to a fifth example embodiment will be described with reference to the drawings. The communication device of the present example embodiment has a configuration in which a reception device and a transmission device are combined. The transmission device has the configuration of any one of the first to fourth example embodiments. The reception device receives the spatial light signal. Hereinafter, an example of a reception device having a light receiving function including a ball lens will be described. Note that the communication device of the present example embodiment may include a reception device including a light receiving function that does not include a ball lens.

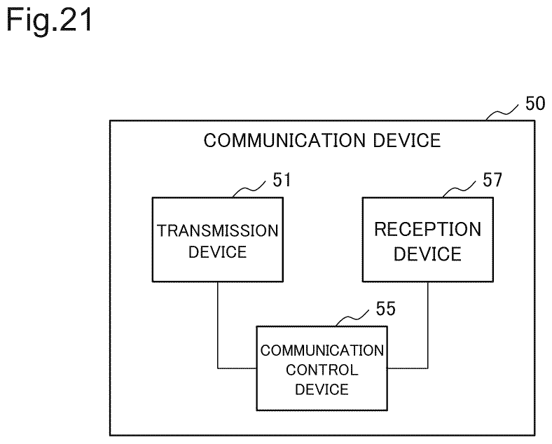

FIG. 21 is a conceptual diagram illustrating an example of a configuration of a communication device 50 according to the present example embodiment. The communication device 50 includes a transmission device 51, a communication control device 55, and a reception device 57. The communication device 50 transmits and receives spatial light signals to and from an external communication target. Therefore, an opening or a window for transmitting and receiving a spatial light signal is formed in the communication device 50.

The transmission device 51 is any one of the transmission devices of the first to fourth example embodiments. The transmission device 51 acquires a control signal from the communication control device 55. The transmission device 51 projects a spatial light signal according to the control signal. The spatial light signal projected from the transmission device 51 is received by a communication target (not illustrated) of a transmission destination of the spatial light signal.

The communication control device 55 acquires a signal output from the reception device 57. The communication control device 55 executes processing according to the acquired signal. The processing executed by the communication control device 55 is not particularly limited. The communication control device 55 outputs a control signal for transmitting an optical signal according to the executed processing to the transmission device 51. For example, the communication control device 55 executes processing based on a predetermined condition according to information included in the signal received by the reception device 57. For example, the communication control device 55 executes processing designated by the administrator of the communication device 50 according to information included in the signal received by the reception device 57.

The reception device 57 receives a spatial light signal transmitted from a communication target (not illustrated). The reception device 57 converts the received spatial light signal into an electrical signal. The reception device 57 outputs the converted electric signal to the communication control device 55. For example, the reception device 57 has a light receiving function including a ball lens. Furthermore, the reception device 57 may have a light receiving function that does not include a ball lens.

[Reception Device]

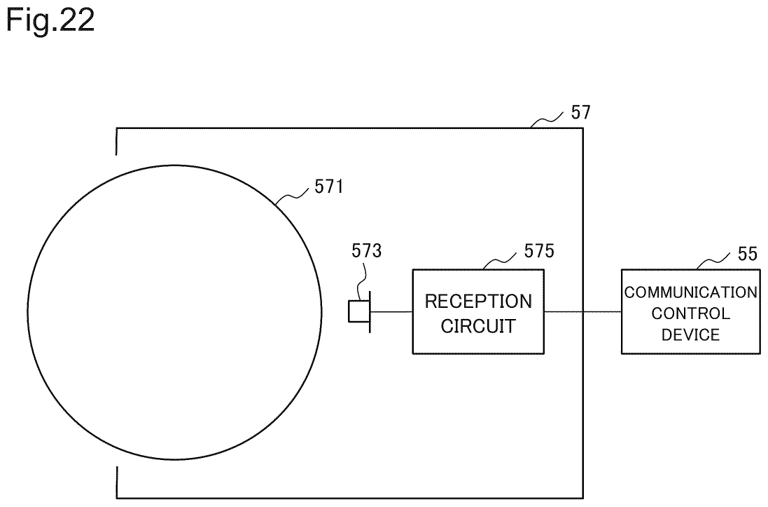

Next, a configuration of the reception device 57 will be described with reference to the drawings. FIG. 22 is a conceptual diagram for describing an example of a configuration of the reception device 57. The reception device 57 includes a ball lens 571, a light-receiving element 573, and a reception circuit 575. FIG. 22 is a side view of the internal configuration of the reception device 57 as viewed from the lateral direction. The position of the reception circuit 575 is not particularly limited. The reception circuit 575 may be disposed inside the reception device 57 or may be disposed outside the reception device 57. Furthermore, the function of the reception circuit 575 may be included in the communication control device 55.

The ball lens 571 is a spherical lens. The ball lens 571 is an optical element that collects a spatial light signal transmitted from a communication target. The ball lens 571 has a spherical shape when viewed from an arbitrary angle. A portion of the ball lens 571 protrudes from an opening opened in a housing of the reception device 57. The ball lens 571 collects the incident spatial light signal. The spatial light signal incident on the ball lens 571 protruding from the opening is collected. As long as the spatial light signal can be condensed, a portion of the ball lens 571 may not protrude from the opening.

The light (optical signal) derived from the spatial light signal condensed by the ball lens 571 is condensed toward the condensing region of the ball lens 571. Since the ball lens 571 has a spherical shape, the ball lens collects a spatial light signal arriving from an arbitrary direction. That is, the ball lens 571 exhibits similar light condensing performance for a spatial light signal arriving from an arbitrary direction. The light incident on the ball lens 571 is refracted when entering the inside of the ball lens 571. Furthermore, the light traveling inside the ball lens 571 is refracted again when being emitted to the outside of the ball lens 571. Most of the light emitted from the ball lens 571 is condensed in the condensing region.

For example, the ball lens 571 can be made of a material such as glass, crystal, or resin. In the case of receiving a spatial light signal in the visible region, the ball lens 571 can be achieved by a material such as glass, crystal, or resin that transmits/refracts light in the visible region. For example, the ball lens 571 can be achieved by optical glass such as crown glass or flint glass. For example, the ball lens 571 can be achieved by a crown glass such as BK (Boron Kron). For example, the ball lens 571 can be achieved by a flint glass such as Lanthanum Schwerflint (LaSF). For example, quartz glass can be applied to the ball lens 571. For example, a crystal such as sapphire can be applied to the ball lens 571. For example, a transparent resin such as acrylic can be applied to the ball lens 571.

In a case where the spatial light signal is light in a near-infrared region (hereinafter, near infrared rays), a material that transmits near-infrared rays is used for the ball lens 571. For example, in a case of receiving a spatial light signal in a near-infrared region of about 1.5 micrometers (μm), a material such as silicon can be applied to the ball lens 571 in addition to glass, crystal, resin, and the like. In a case where the spatial light signal is light in an infrared region (hereinafter, infrared rays), a material that transmits infrared rays is used for the ball lens 571. For example, in a case where the spatial light signal is an infrared ray, silicon, germanium, or a chalcogenide material can be applied to the ball lens 571. The material of the ball lens 571 is not limited as long as light in the wavelength region of the spatial light signal can be transmitted/refracted. The material of the ball lens 571 may be appropriately selected according to the required refractive index and use.

The ball lens 571 may be replaced with another concentrator as long as the spatial light signal can be condensed toward the region where the light-receiving element 573 is disposed. For example, the ball lens 571 may be a light beam control element that guides the incident spatial light signal toward the light-receiving portion of the light-receiving element 573. For example, the ball lens 571 may have a configuration in which a lens or a light beam control element is combined. For example, a mechanism that guides the optical signal condensed by the ball lens 571 toward the light-receiving portion of the light-receiving element 573 may be added.

The light-receiving element 573 is disposed at a subsequent stage of the ball lens 571. The light-receiving element 573 is disposed in the condensing region of the ball lens 571. The light-receiving element 573 includes a light-receiving portion that receives the optical signal collected by the ball lens 571. The light signal collected by the ball lens 571 is received by the light-receiving portion of the light-receiving element 573. The light-receiving element 573 converts the received optical signal into an electric signal (hereinafter, a signal). The light-receiving element 573 outputs the converted signal to the reception circuit 575. FIG. 22 illustrates an example in which the light-receiving element 573 is a single element. For example, the plurality of light-receiving elements 573 may be arranged in the condensing region of the ball lens 571. For example, a light-receiving element array in which a plurality of light-receiving elements 573 is arrayed may be arranged in the condensing region of the ball lens 571.

The light-receiving element 573 receives light in a wavelength region of the spatial light signal to be received. For example, the light-receiving element 573 has sensitivity to light in the visible region. For example, the light-receiving element 573 has sensitivity to light in an infrared region. The light-receiving element 573 is sensitive to light having a wavelength in a 1.5 μm (micrometer) band, for example. Note that the wavelength band of light to which the light-receiving element 573 is sensitivity is not limited to the 1.5 μm band. The wavelength band of the light received by the light-receiving element 573 can be arbitrarily set in accordance with the wavelength of the spatial light signal to be received. The wavelength band of the light received by the light-receiving element 573 may be set to, for example, a 0.8 μm band, a 1.55 μm band, or a 2.2 μm band. Furthermore, the wavelength band of the light received by the light-receiving element 573 may be, for example, a 0.8 to 1 μm band. A shorter wavelength band is advantageous for optical spatial communication during rainfall because absorption by moisture in the atmosphere is small. In addition, if the light-receiving element 573 is saturated with intense sunlight, the light-receiving element cannot read the optical signal derived from the spatial light signal. Therefore, a color filter that selectively passes the light of the wavelength band of the spatial light signal may be installed at the preceding stage of the light-receiving element 573.

For example, the light-receiving element 573 can be achieved by an element such as a photodiode or a phototransistor. For example, the light-receiving element 573 is achieved by an avalanche photodiode. The light-receiving element 573 achieved by the avalanche photodiode can support high-speed communication. Note that the light-receiving element 573 may be achieved by an element other than a photodiode, a phototransistor, or an avalanche photodiode as long as an optical signal can be converted into an electric signal. In order to improve the communication speed, the light-receiving portion of the light-receiving element 573 is preferably as small as possible. For example, the light-receiving portion of the light-receiving element 573 has a square light-receiving surface having a side of about 5 mm (mm). For example, the light-receiving portion of the light-receiving element 573 has a circular light-receiving surface having a diameter of about 0.1 to 0.3 mm. The size and shape of the light-receiving portion of the light-receiving element 573 may be selected according to the wavelength band, the communication speed, and the like of the spatial light signal.

For example, a polarizing filter (not illustrated) may be disposed in front of the light-receiving element 573. The polarizing filter is disposed in association with the light-receiving portion of the light-receiving element 573. For example, the polarizing filter is disposed to overlap the light-receiving portion of the light-receiving element 573. For example, the polarization filter may be selected according to the polarization state of the spatial light signal to be received. For example, when the spatial light signal to be received is linearly polarized light, the polarizing filter includes a ½ wave plate. For example, when the spatial light signal to be received is circularly polarized light, the polarizing filter includes a ¼ wave plate. The polarization state of the optical signal having passed through the polarizing filter is converted according to the polarization characteristic of the polarizing filter.

The reception circuit 575 acquires a signal output from the light-receiving element 573. The reception circuit 575 amplifies the signal from the light-receiving element 573. The reception circuit 575 decodes the amplified signal. The signal decoded by the reception circuit 575 is used for any purpose. The use of the signal decoded by the reception circuit 575 is not particularly limited.

[Communication Device]

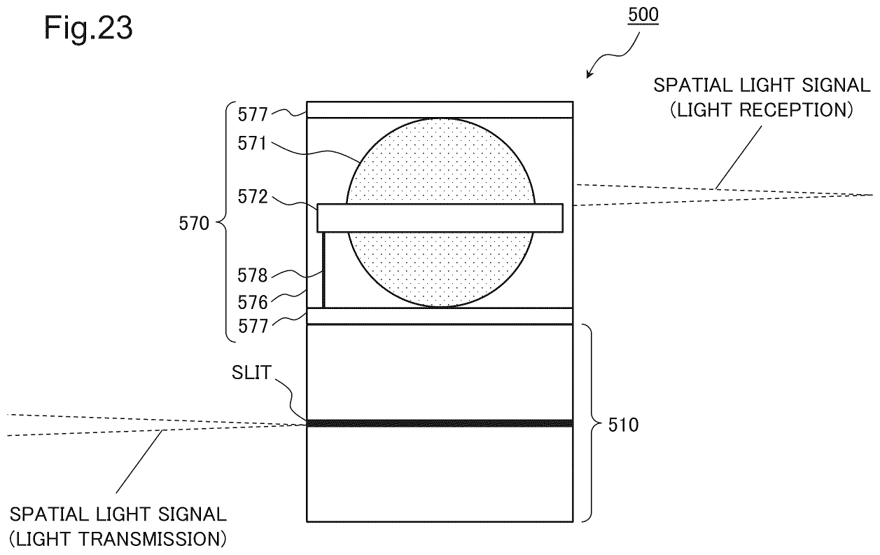

FIG. 23 is a conceptual diagram illustrating an example (communication device 500) of the communication device 50. The communication device 500 includes a transmitter 510, a receiver 570, and a communication control device (not illustrated). In FIG. 23, a reception circuit and a communication control device are omitted. The reception circuit and the communication control device are disposed inside the communication device 500. The communication device 500 has a configuration in which the transmitter 510 having a cylindrical outer shape and the receiver 570 are combined.

The receiver 570 includes a ball lens 571, a light receiver 572, a color filter 576, and a support member 577. The upper and lower portions of the ball lens 571 are sandwiched between a pair of support members 577 arranged vertically. Since the upper and lower sides of the ball lens 571 are not used for transmission and reception of spatial light signals, they may be processed into a planar shape so as to be easily sandwiched by the support member 577. The light receiver 572 is arranged in accordance with the condensing region of the ball lens 571 so as to be able to receive the spatial light signal to be received. The light receiver 572 includes a light-receiving element array in which a plurality of light-receiving elements is annularly arranged. The plurality of light-receiving elements are arranged in the condensing region of the ball lens 571. The plurality of light-receiving elements are arranged with the light-receiving portion facing the ball lens 571. The plurality of light-receiving elements are connected to a control device (not illustrated) and the transmitter 510 by a conductive wire 578.

The color filter 576 is disposed on a side surface of the cylindrical receiver 570. The color filter 576 removes unnecessary light and selectively transmits a spatial light signal used for communication. A pair of support members 577 is disposed on upper and lower surfaces of the cylindrical receiver 570. The pair of support members 577 sandwich the ball lens 571 from above and below. A light receiver 572 formed in an annular shape is arranged around the ball lens 571. The light receiver 572 includes a plurality of light-receiving elements in which the light receiver faces the ball lens 571. The spatial light signal incident on the ball lens 571 through the color filter 576 is condensed toward the light receiver 572 by the ball lens 571. The optical signal condensed on the light receiver 572 is guided toward the light-receiving portion of one of the light-receiving elements. The light signal reaching the light-receiving portion of the light-receiving element is received by the light-receiving element. A communication control device (not illustrated) decodes an optical signal received by a light-receiving element included in the light receiver 572. The communication control device causes the transmitter 510 to transmit the spatial light signal according to the decoded optical signal.

The transmitter 510 is configured by any one of the transmission devices of the first to fourth example embodiments. The transmitter 510 is housed inside a cylindrical housing. A slit opened in accordance with the transmission direction of the spatial light signal by the transmitter 510 is formed in the cylindrical housing. For example, in a case where the transmitter 510 can transmit the spatial light signal in the direction of 360 degrees, a slit is formed on the side surface of the housing of the transmitter 510 in accordance with the transmission direction of the spatial light signal.

### Application Example

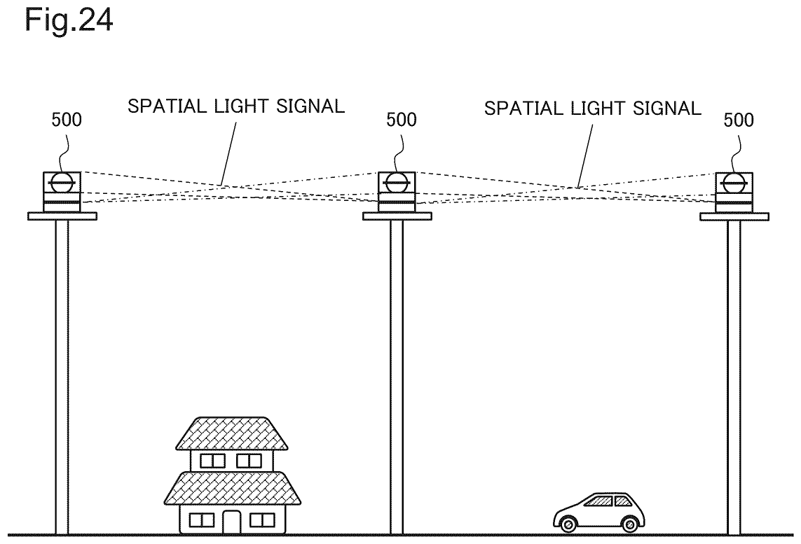

Next, an application example of the present example embodiment will be described with reference to the drawings. In the following application example, an example in which a plurality of communication devices 500 transmit and receive spatial light signals will be described. FIG. 24 is a conceptual diagram for describing the present application. In the present application example, an example (communication system) of a communication network in which a plurality of communication devices 500 is arranged on an upper portion (space above a pole) of a pole such as a utility pole or a street lamp arranged in a town will be described.

There are few obstacles in the space above the pole. Therefore, the space above the pole is suitable for installing the communication device 500. In addition, if the communication device 500 is installed at the same height, the arrival direction of the spatial light signal is limited to the horizontal direction. Therefore, the light-receiving area of the light receiver constituting the receiver 570 can be reduced, and the device can be simplified. The pair of communication devices 500 that transmit and receive the spatial light signal is arranged such that at least one communication device 500 receives the spatial light signal transmitted from the other communication device 500. The pair of communication devices 500 may be arranged to transmit and receive spatial light signals to and from each other. In a case where the communication network of the spatial light signal is configured by the plurality of communication devices 500, the communication device 500 positioned in the middle may be arranged to relay the spatial light signal transmitted from another communication device 500 to another communication device 500.

According to the present application example, communication using a spatial light signal can be performed among the plurality of communication devices 500 arranged in the space above a pole. For example, communication by wireless communication may be performed between a wireless device or a base station installed in an automobile, a house, or the like and the communication device 500 according to communication between the communication devices 500. For example, the communication device 500 may be connected to the Internet via a communication cable or the like installed on a pole.

As described above, the communication device according to the present example embodiment includes the reception device, the transmission device, and the communication control device. The transmission device is at least one of the transmission devices (transmitters) according to the first to fourth example embodiments. The reception device receives a spatial light signal from another communication device. The communication control device acquires a signal based on a spatial light signal from another communication device received by the reception device. The communication control device executes processing according to the acquired signal. The communication control device causes the transmission device to transmit a spatial light signal corresponding to the executed processing.

A transmission device included in a communication device according to the present example embodiment separates beams of a spatial light signal (projection light) into a plurality of beams by reflecting illumination light derived from light emitted from a plurality of light emitters by a plurality of reflecting surfaces. According to the present example embodiment, multiple beams including a plurality of beams are transmitted as a spatial light signal (projection light). Therefore, according to the present example embodiment, even if one beam is blocked by raindrops in rainfall, there is a high possibility that another beam reaches the communication target. According to the present example embodiment, by making the spatial light signal (projection light) into multiple beams, it is possible to realize continuous optical spatial communication which is hardly affected by the weather.

A communication system according to an aspect of the present example embodiment includes a plurality of the above-described communication devices. In a communication system, a plurality of communication devices are arranged to transmit and receive spatial light signals to and from each other. According to the present aspect, it is possible to realize a communication network that transmits and receives a spatial light signal.

### Sixth Example Embodiment

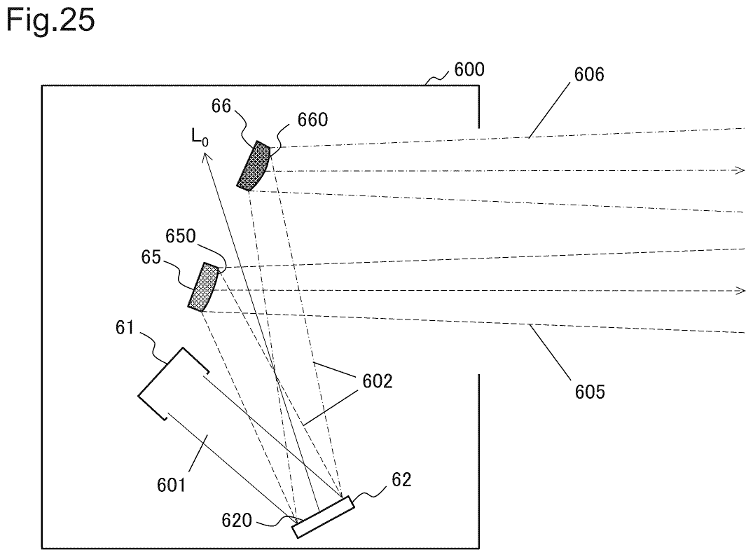

Next, a transmission device according to a sixth example embodiment will be described with reference to the drawings. The transmission device of the present example embodiment has a simplified configuration of the transmitters included in the transmission devices of the first to fourth example embodiments. FIG. 25 is a conceptual diagram illustrating an example of a configuration of a transmitter 600 according to the present example embodiment. FIG. 25 is a side view of the internal configuration of the transmitter 600 as viewed from the lateral direction. The transmitter 600 includes a light source 61, a spatial light modulator 62, a first mirror 65, and a second mirror 66. Shapes and positional relationships of the light source 61, the spatial light modulator 62, the first mirror 65, and the second mirror 66 are conceptual, and are not accurately described.

The light source 61 includes a first light emitter and a second light emitter. The spatial light modulator 62 includes a modulation part 620 that modulates the light 601 emitted from the light source 61. The first mirror 65 is disposed on the first optical path of the modulated light 602 modulated by the modulation part 620. The first mirror 65 reflects the modulated light 602 in the first projection direction. The modulated light 602 reflected by first mirror 65 is projected as the projection light 605. The second mirror 66 is disposed on the second optical path of the modulated light 602 modulated by the modulation part 620. The second mirror 66 reflects the modulated light 602 in the first projection direction. The modulated light 602 reflected by second mirror 66 is projected as the projection light 606.

As described above, in the present example embodiment, the projection light (spatial light signal) configured by the two beams derived from the light emitted from the two light emitters is projected in the same first projection direction. According to the present example embodiment, even if one of the two beams included in the spatial light signal is shielded due to the influence of rainfall, the possibility that the other beam reaches the communication target increases. That is, according to the present example embodiment, it is possible to realize continuous optical space communication which is hardly affected by the weather.

(Hardware)

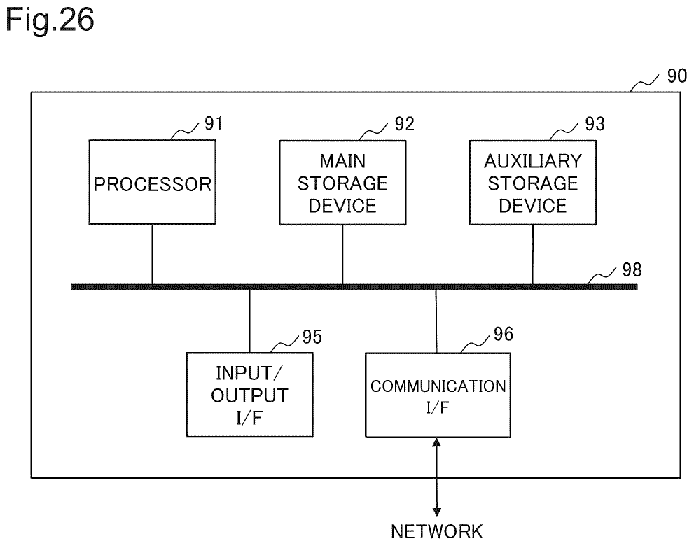

Here, a hardware configuration for executing control and processing according to each example embodiment of the present disclosure will be described using the information processing device 90 (computer) of FIG. 26 as an example. Note that the information processing device 90 in FIG. 26 is a configuration example for executing control and processing of each example embodiment, and does not limit the scope of the present disclosure.

As illustrated in FIG. 26, the information processing device 90 includes a processor 91, a main storage device 92, an auxiliary storage device 93, an input/output interface 95, and a communication interface 96. In FIG. 26, the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing control and processing of each example embodiment. The processor 91 executes the program developed in the main storage device 92. The processor 91 executes the program to execute control and processing according to each example embodiment.

The main storage device 92 has an area in which a program is developed. A program stored in the auxiliary storage device 93 or the like is developed in the main storage device 92 by the processor 91. The main storage device 92 is, for example, a volatile memory such as a dynamic random access memory (DRAM). A nonvolatile memory such as a magnetoresistive random access memory (MRAM) may be configured and added as the main storage device 92.

The auxiliary storage device 93 stores diverse types of data such as programs. The auxiliary storage device 93 is a local disk such as a hard disk or a flash memory. Various types of data may be stored in the main storage device 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a standard or a specification. The input/output interface 95 and the communication interface 96 may be shared as an interface connected to an external device.

Input devices such as a keyboard, a mouse, and a touch panel may be connected to the information processing device 90 as necessary. These input devices are used for inputting information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 includes a display control device (not illustrated) for controlling display of the display device. The information processing device 90 and the display device are connected via the input/output interface 95.

The information processing device 90 may be provided with a drive device. The drive device mediates reading of data and a program stored in a recording medium and writing of a processing result from the information processing device 90 to the recording medium between the processor 91 and the recording medium (program recording medium). The information processing device 90 and the drive device are connected via an input/output interface 95.

The above is an example of a hardware configuration for enabling control and processing according to each example embodiment of the present invention. The hardware configuration of FIG. 26 is an example of a hardware configuration for executing control and processing according to each example embodiment, and does not limit the scope of the present invention. A program for causing a computer to execute control and processing according to each example embodiment is also included in the scope of the present invention.

A program recording medium in which the program according to each example embodiment is recorded is also included in the scope of the present invention. The recording medium can be achieved by, for example, an optical recording medium such as a compact disc (CD) or a digital versatile disc (DVD). The recording medium may be a semiconductor recording medium such as a universal serial bus (USB) memory or a secure digital (SD) card. The recording medium may be a magnetic recording medium such as a flexible disk, or another recording medium. In a case where the program executed by the processor is recorded in the recording medium, the recording medium corresponds to a program recording medium.

The components of the example embodiments may be arbitrarily combined. The components of the example embodiments may be implemented by software. The components of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A transmitter comprising:
a light source including a first light emitter and a second light emitter;
a spatial light modulator including a modulation part that modulates light emitted from the light source;
a first mirror that is disposed on a first optical path of modulated light modulated by the modulation part and reflects the modulated light in a first projection direction; and
a second mirror that is disposed on a second optical path of the modulated light modulated by the modulation part and reflects the modulated light in the first projection direction.

2. The transmitter according to claim 1, wherein
the first mirror and the second mirror are arranged while avoiding a position irradiated with a ghost image of desired light included in the modulated light and a position irradiated with 0th-order light included in the modulated light.

3. The transmitter according to claim 2, wherein
the first mirror and the second mirror have a convex curved reflecting surface, and are disposed with the reflecting surface facing the first projection direction.

4. The transmitter according to claim 3, further comprising:
a third mirror having a convex curved reflecting surface and disposed with the reflecting surface facing the first projection direction, wherein
the light source further includes a third light emitter, and
the third mirror is disposed on a third optical path of the modulated light modulated by the modulation part, and reflects the modulated light toward the first projection direction.

5. The transmitter according to claim 2, wherein
the light source further includes a third light emitter and a fourth light emitter,
each of the first mirror and the second mirror has two convex curved reflecting surfaces, and the two reflecting surfaces are arranged in the first projection direction, and
one of the four reflecting surfaces of the first mirror and the second mirror is irradiated with the modulated light derived from light emitted from the first light emitter, the second light emitter, the third light emitter, and the fourth light emitter.

6. The transmitter according to claim 2, wherein
the light source further includes a third light emitter and a fourth light emitter,
each of the first mirror and the second mirror has a convex curved reflecting surface, and is disposed with the reflecting surface facing the first projection direction, and
one of the reflecting surfaces of the first mirror and the second mirror is irradiated with the modulated light derived from light emitted from the first light emitter, the second light emitter, the third light emitter, and the fourth light emitter.

7. A transmission device comprising:
the transmitter according to claim 1;
a memory storing instructions; and
a processor connected to the memory and configured to execute the instructions to
set a phase image used for spatial light communication in a modulation part of a spatial light modulator included in the transmitter, and
control a light source included in the transmitter such that the modulation part is irradiated with light.

8. The transmission device according to claim 7, wherein
the processor is configured to execute the instructions to
drive a plurality of light emitters included in the light source at timings independent from each other.

9. A communication device comprising:
a transmission device including the transmitter according to claim 1;
a reception device that receives a spatial light signal from another communication device; and
a communication control device that comprises
a memory storing instructions; and
a processor connected to the memory and configured to execute the instructions to
acquire a signal based on the spatial light signal received by the reception device, executes processing according to the acquired signal, and
cause the transmission device to transmit a spatial light signal according to the executed processing.

10. A communication system comprising:
a plurality of the communication devices according to claim 9, wherein
the plurality of the communication devices are arranged to transmit and receive spatial light signals to and from each other.
